(19) United States
(12) Patent Application Publication
(10) Pub. No.: US 2024/0035971 A1
(43) Pub. Date: Feb. 1, 2024

(54) SYSTEM AND METHOD FOR FLUORESCENCE LIFETIME IMAGING

(71) Applicant: Board of Regents, The University of Texas System, Austin, TX (US)

(72) Inventors: Hsin-Chih Yeh, Austin, TX (US); Yuan-I Chen, Austin, TX (US); Yin-Jui Chang, Austin, TX (US); Shih-Chu Liao, Champaign, IL (US); Trung Duc Nguyen, Austin, TX (US); Soonwoo Hong, Austin, TX (US); Yu-An Kuo, Austin, TX (US); Hsin-Chin Li, Austin, TX (US)

(21) Appl. No.: 18/245,804

(22) PCT Filed: Sep. 17, 2021
(86) PCT No.: PCT/US2021/050864

§ 371 Date: Mar. 17, 2023

Related U.S. Application Data
(60) Provisional application No. 63/080,190, filed on Sep. 18, 2020.

(51) Int. Cl. G01N 21/64

(52) U.S. Cl. CPC G01N 21/6408; G01N 21/6458

(57) ABSTRACT

A fluorescence lifetime imaging microscopy system comprises a microscope comprising an excitation source configured to direct an excitation energy to an imaging target, and a detector configured to measure emissions of energy from the imaging target, and a non-transitory computer-readable medium with instructions stored thereon, which perform steps comprising collecting a quantity of measured emissions of energy from the imaging target as measured data, providing a trained neural network configured to calculate fluorescent decay parameters from the quantity of measured emissions of energy, providing the data to the trained neural network, and calculating at least one fluorescence lifetime parameter with the neural network from the measured data, wherein the measured data comprises an input fluorescence decay histogram, and wherein the neural network was trained by a generative adversarial network. A method of training a neural network and a method of acquiring an image are also described.

### CROSS-REFERENCE TO RELATED APPLICATIONS

This application claims priority to U.S. Provisional Application No. 63/080,190, filed on Sep. 18, 2020, incorporated herein by reference in its entirety.

### BACKGROUND OF THE INVENTION

Fluorescence lifetime imaging microscopy (FLIM) is a powerful tool for producing an image based on the differences in the exponential decay rate of the fluorescence. Fluorescence lifetime measurements are able to distinguish between different fluorescent probes with very similar fluorescence spectra due to intensity-independent measurement. As the decay rate is an intrinsic property of a fluorophore, lifetime images are not skewed by excitation power and fluorophore concentration, as is the case in bias intensity-based images. Whereas the fluorescence emission spectrum is also an intrinsic property of a fluorophore, spectrum characterization can also be skewed by the inner-filter effect at a high absorber concentration. Because the fluorescence lifetime is sensitive to the environment where the fluorophore is contained and to the binding status of the fluorophore, FLIM is a great method to monitor the pH, metabolic state, viscosity, hydrophobicity, oxygen content, and temperature inside live cells. FLIM may also be used to monitor one or more functional properties of biomarkers.

In addition, by monitoring donor lifetime, FLIM can directly characterize molecular interaction with fluorescence resonance energy transfer (FRET) efficiency without taking any acceptor fluorescence into the measurement. FLIM-based FRET sensing methods, for instance, have been widely used to probe Ca²⁺ concentration, glucose concentration, and protein-protein interactions without the need to measure acceptor's fluorescence. As different fluorophores can exhibit disparate fluorescence decay patterns under the same excitation, fluorescence lifetime serves as a unique parameter for barcode encoding. With many unique advantages, FLIM has become an important tool in quantifying molecular interactions and chemical environment in biological or chemical samples.

One current challenge in fluorescence lifetime analysis is the difficulty to obtain an accurate fluorescence lifetime estimate at each pixel in a reliable, timely manner. Currently, FLIM images can be produced in the time domain or the frequency domain. Using the time-domain fluorescence lifetime characterization as an example, photons collected from each pixel are put into a histogram and fit with a single- or multi-exponential decay model. While the lifetimes and the relative abundances of fluorescent components can be obtained based on the least-squares estimation (TD_LSE), the TD_LSE method is computationally expensive—it takes tens of minutes to hours to generate a 512×512 FLIM image. Typically, thousands of time-tagged photons are required to generate a high-quality FLIM image. Although previous reports have shown that a fluorescence lifetime can be obtained based on as few as 100 photons using a maximum likelihood estimator (TD_MLE), such an estimate is very noisy and the TD_MLE method does not increase the analysis speed, as such methods require multiple days to produce a single FLIM image. In addition, available methods fail to consider the instrument response function (IRF), thereby producing biased results.

The frequency-domain method, on the other hand, has significantly simplified and increased the speed of lifetime image acquisition and analysis. While a few frequency sweeping data points are sufficient for a lifetime estimate (DFD_LSE), the frequency-domain method typically requires high photon counts from each pixel. There has not been a fluorescence lifetime analysis method that is fast, accurate and reliable with low photon budget (a few hundred photons at each pixel).

Thus, there is a need in the art for improved methods of fluorescence lifetime analysis accurate, and reliable at low photon counts. The present invention satisfies this unmet need.

### SUMMARY OF THE INVENTION

In one aspect, a fluorescence lifetime imaging microscopy system comprises a microscope, comprising an excitation source configured to direct an excitation energy to an imaging target, and a detector configured to measure emissions of energy from the imaging target, and a non-transitory computer-readable medium with instructions stored thereon, which when executed by a processor perform steps comprising collecting a quantity of measured emissions of energy from the imaging target as measured data, providing a trained neural network configured to calculate fluorescent decay parameters from the quantity of measured emissions of energy, providing the measured data to the trained neural network, and calculating at least one fluorescence lifetime parameter with the neural network from the measured data, wherein the measured data comprises an input fluorescence decay histogram having a photon count of no more than 200, and wherein the neural network was trained by a generative adversarial network.

In one embodiment, the steps further comprise providing an instrument response function curve to the trained neural network. In one embodiment, the measured data comprises a fluorescence decay histogram having a photon count of no more than 100. In one embodiment, the steps further comprise generating a synthetic fluorescence decay histogram having a photon count higher than the input fluorescence decay histogram and calculating the at least one fluorescence lifetime parameter from the synthetic fluorescence decay histogram.

In one embodiment, the steps further comprise calculating a center of mass of an instrument response function curve, calculating a center of mass of the input fluorescence decay histogram, and time-shifting the input fluorescence decay histogram based on a difference between the center of mass of the instrument response function curve and the center of mass of the input fluorescence decay histogram.

In one embodiment, the excitation source comprises at least one laser. In one embodiment, the at least one laser comprises a plurality of lasers configured to deliver sub-nanosecond pulses. In one embodiment, the detector comprises a scanning mirror. In one embodiment, the detector comprises at least one pinhole. In one embodiment, the generative adversarial network is a Wasserstein generative adversarial network.

In one aspect, a method of training a neural network for a fluorescence lifetime imaging microscopy system comprises generating a synthetic high-count fluorescence lifetime decay histogram from an instrument response function and an exponential decay curve, generating a synthetic low-count fluorescence lifetime decay histogram from the synthetic high-count fluorescence lifetime decay histogram, providing a generative adversarial network comprising a generator network and a discriminator network, generating a plurality of candidate high-count fluorescence lifetime decay histograms from the synthetic low-count fluorescence lifetime decay histogram with the generator network, training the discriminator network with the synthetic high-count fluorescence lifetime decay histograms and the candidate high-count fluorescence lifetime decay histograms, and training the generator network with the results of the discriminator network training, wherein the synthetic low-count fluorescence lifetime decay histogram has a photon count of no more than 200.

In one embodiment, the synthetic high-count fluorescence lifetime decay histogram are generated by a Monte Carlo simulation. In one embodiment, the synthetic low-count fluorescence decay histogram is generated by a Monte Carlo simulation. In one embodiment, the method further comprises providing an instrument response function curve, convolving the instrument response function curve with a two-component exponential decay equation to provide a continuous fluorescence exponential decay curve, and performing the Monte Carlo simulation with the continuous fluorescence decay curve to generate the synthetic low-count decay histogram.

In one embodiment, the method further comprises normalizing the continuous fluorescence exponential decay curve. In one embodiment, the synthetic low-count fluorescence decay histogram is generated by a Poisson process. In one embodiment, the method further comprises providing a plurality of high-count fluorescence lifetime decay histograms with known lifetime parameters and training an estimator network with the plurality of high-count fluorescence lifetime decay histograms and the known lifetime parameters to calculate estimated lifetime parameters. In one embodiment, the method further comprises selecting a subset of the candidate high-count fluorescence decay histograms, selecting a subset of the synthetic high-count decay histograms, and training the discriminator network with the subset of candidate high-count fluorescence decay histograms and the subset of synthetic high-count decay histograms, to discriminate between a true high-count decay histogram and a synthetic high-count decay histogram. In one embodiment, the method further comprises training a denoising neural network with a plurality of noisy fluorescence decay histograms and a plurality of generated, low-noise fluorescence decay histograms, the trained denoising neural network configured as a pre-processing step for the generative adversarial network.

In one aspect, a method of acquiring an image from a fluorescence lifetime imaging microscopy system comprises providing a microscope comprising an excitation source and a detector, directing an excitation energy to an imaging target, collecting a quantity of measured emissions of energy from the imaging target with the detector as measured data, providing a trained neural network configured to calculate fluorescent decay parameters from the quantity of measured emissions of energy, providing the measured data to the trained neural network, calculating at least one fluorescence lifetime parameter with the neural network from the measured data and repeating the collecting and calculating steps to generate an at least two-dimensional fluorescence lifetime image of the imaging target, wherein the measured data comprises an input fluorescence decay histogram having a photon count of no more than 200, and wherein the neural network was trained by a generative adversarial network.

In one embodiment, the neural network comprises a generator network configured to generate a synthetic fluorescence decay histogram from the input fluorescence decay histogram, the synthetic fluorescence decay histogram having a higher photon count than the input fluorescence decay histogram. In one embodiment, the neural network further comprises an estimator network configured to estimate the values of at least one fluorescence lifetime parameter from the synthetic fluorescence decay histogram. In one embodiment, the method further comprises providing the trained neural network with an instrument response function. In one embodiment, the method further comprises performing an unsupervised cluster analysis, grouping a set of pixels with similar patterns, and summing the set of pixels in order to increase the signal-to-noise ratio of the input fluorescence decay histogram. In one embodiment, the at least two-dimensional fluorescence lifetime image of the imaging target is generated at least 20× faster than with a conventional analysis method.

### BRIEF DESCRIPTION OF THE DRAWINGS

The following detailed description of various embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1A is a schematic structure of the neural network elements according to one embodiment.

FIG. 1B depicts a schematic representation of a deep learning framework.

FIG. 1C is a schematic diagram of an exemplary generator and discriminator network.

FIG. 1D is a schematic diagram of an exemplary estimator network.

FIG. 1E is a schematic diagram of an exemplary neural network.

FIG. 1F is an exemplary timeline of a training process for a neural network.

FIG. 2A shows a graphical view of the calibration line calculation.

FIG. 2B shows a calibration line for decay histogram shifting.

FIG. 2C shows a graphical view of implementation of a calibration line for decay histogram shifting.

FIG. 3A is a graphical representation of the transformation from a low-photon-count decay curve to a high-photon-count decay curve.

FIG. 3B is a schematic representation of a denoising network.

FIG. 4 is a schematic diagram of a FLIM system.

FIG. 5 is a graphical representation of a Monte Carlo (MC) data generation method.

FIG. 6 is a schematic representation of a MC-based approach to generate fluorescence lifetime decay histogram in-silico.

FIG. 7 depicts a comparison of representative Poisson process simulation and MC simulation methods.

FIG. 8A depicts a comparison of representative FLIM images generated by different methods.

FIG. 8B depicts a graphical representation of a Center of Mass Evaluation preprocessing step.

FIG. 8C depicts representative results demonstrating that the model successfully characterized apparent lifetime of the mixture of two fluorescent dyes with 10 different ratios in solution. The numeral above each histogram is the mean lifetime±lifetime coefficient of variation from Gaussian distribution fitting.

FIG. 8D shows experimental results accurately characterizing apparent lifetime of a mixture of two fluorescent dyes in 10 different ratios in solution.

FIG. 9 is a comparison of model performance between TD_LSE, TD_MLE, DFD_LSE, and flimGANE.

FIG. 10 is a graph of mean squared error and SSIM of TD_LSE, TD_MLE, DFD_LSE, flimGANE with respect to the ground truth.

FIG. 11A depicts structure representation enhancement in FLIM using convallaria cover slides and live HeLa cells and related data.

FIG. 11B depicts images of the plasma membrane of live HeLa cells and related experimental data.

FIG. 12A depicts a schematic of CFP-g-YFP FRET pair interaction with glucose and related experimental data and images.

FIG. 12B depicts the selection of CFP-g-YFP-transfected cells from fluorescence image.

FIG. 12C depicts the quantification of CFP-g-YFP-transfected MDA-MB-231 cell FLIM images for YFP channel.

FIG. 13 depicts intensity contrast images and FLIM images of FAD and NADH, and related data.

FIG. 14 shows graphs of quality index threshold for TD_LSE, TD_MLE, DFD_LSE, and flimGANE.

FIG. 15 shows a comparison of TD_MLE tested on simulated decay histograms or on Gₒᵤₜₚᵤₜ (TD_MLE_{G_output}) and flimGANE.

FIG. 16 shows a comparison of WGAN and GAN algorithms on learning to reconstruct ground-mimicking fluorescence decay histograms.

FIG. 17A depicts comparisons of FLIM images of fluorescence barcodes generated by different methods.

FIG. 17B depicts comparisons of FLIM images identifying different barcode beads with the flimGANE method.

FIG. 17C depicts several detail views corresponding to the images in FIG. 17A, and related data.

FIG. 17D depicts two dimensional (intensity versus lifetime) scatter plots showing three distinct populations can be identified by flimGANE.

FIG. 17E shows two dimensional (intensity versus lifetime) scatter plots from different methods illustrating the success of flimGANE in identifying three populations of barcodes with nearly the same size.

FIG. 18A shows a schematic diagram of a method for calculating a quality score according to the disclosure.

FIG. 18B shows a plot of a loss function.

FIG. 18C is a graph depicting the dependency of the squared error of the lifetime estimate and the G-quality score.

FIG. 18D is a schematic diagram of flimGANE quality estimate SOP given the input decay histogram from a live HeLa cell sample.

FIG. 19A is a set of graphs of mean squared error in a generator and an estimator across multiple training iterations.

FIG. 19B is a set of FLIM images generated by Bayesian optimization and flimGANE.

FIG. 19C is a scatter plot of the squared error between the flimGANE results and a reference.

FIG. 20A shows a schematic workflow of a simulation process to evaluate performance over the variability of IRF.

FIG. 20B is a set of graphs showing the mean-squared error between lifetime estimates and the ground truth over disparate IRF's FWHM.

FIG. 21A shows a discriminability test used to evaluate the statistical significance of the difference between any two lifetime distributions.

FIG. 21B is a graph showing that the decays with lifetime difference of 0.03 ns were indistinguishable.

FIG. 21C is a graph showing that the decays with lifetime difference of 0.15 ns were distinguishable.

FIG. 21D is a heatmap of discriminability of TD_LSE, TD_MLE, DFD_LSE, and flimGANE under different photon-count conditions.

FIG. 22A and FIG. 22B are views of a software graphical user interface.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

Systems and methods disclosed herein relate to improved methods for generating fluorescence lifetime (FLIM) images with low photon counts. Reducing excitation power in FLIM is highly desired as it minimizes photobleaching and phototoxicity in live-cell observation, however the resulting low photon counts make precise lifetime estimation challenging, resulting in low quality images. Using machine learning techniques, for example generative adversarial networks, the disclosed systems and methods are able to perform rapid and reliable analysis of complex fluorescence decays at low photon budgets. The disclosed systems and methods advantageously produce high-fidelity images and accurate quantitative results under low-light conditions, and do so with excellent efficiency, orders of magnitude faster than existing methods.

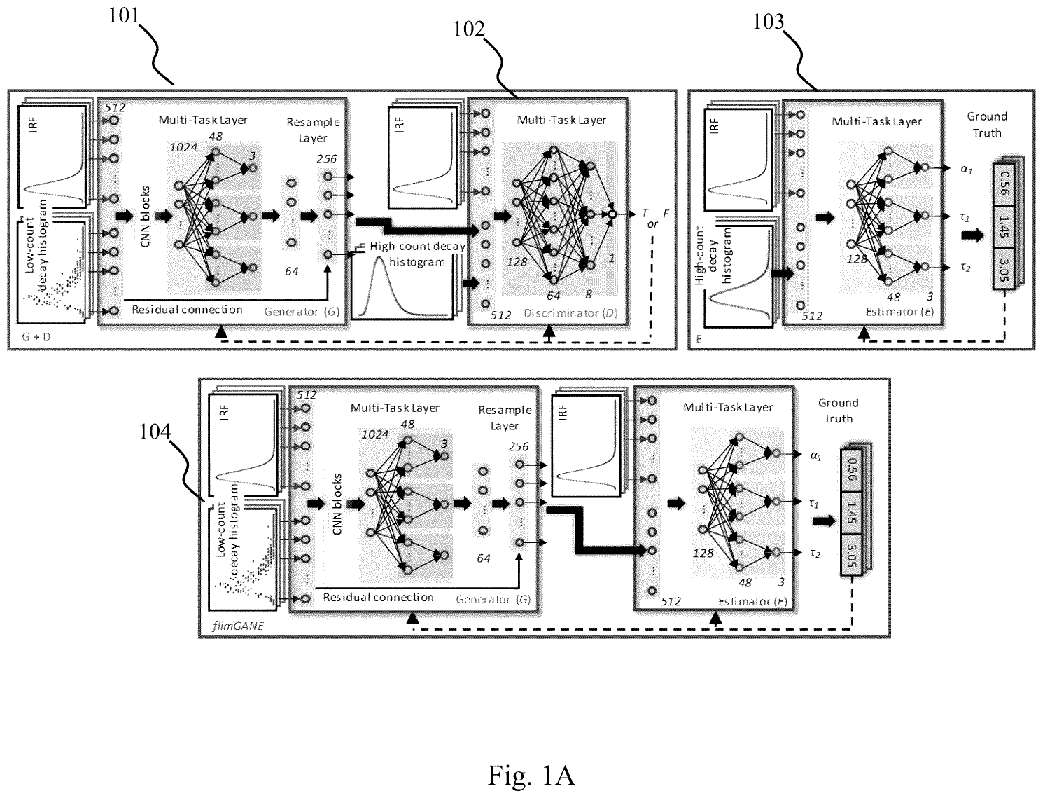

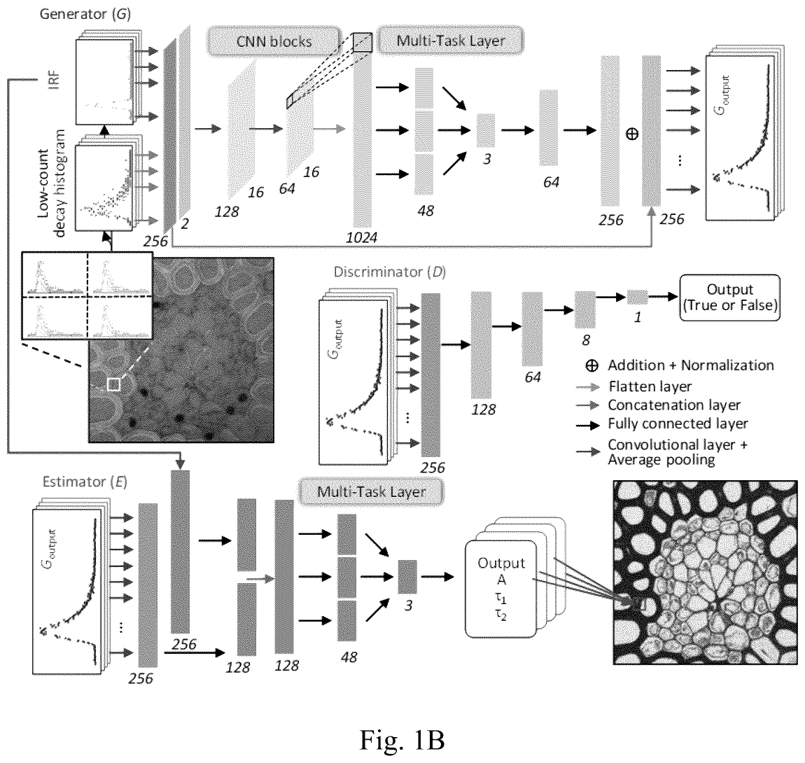

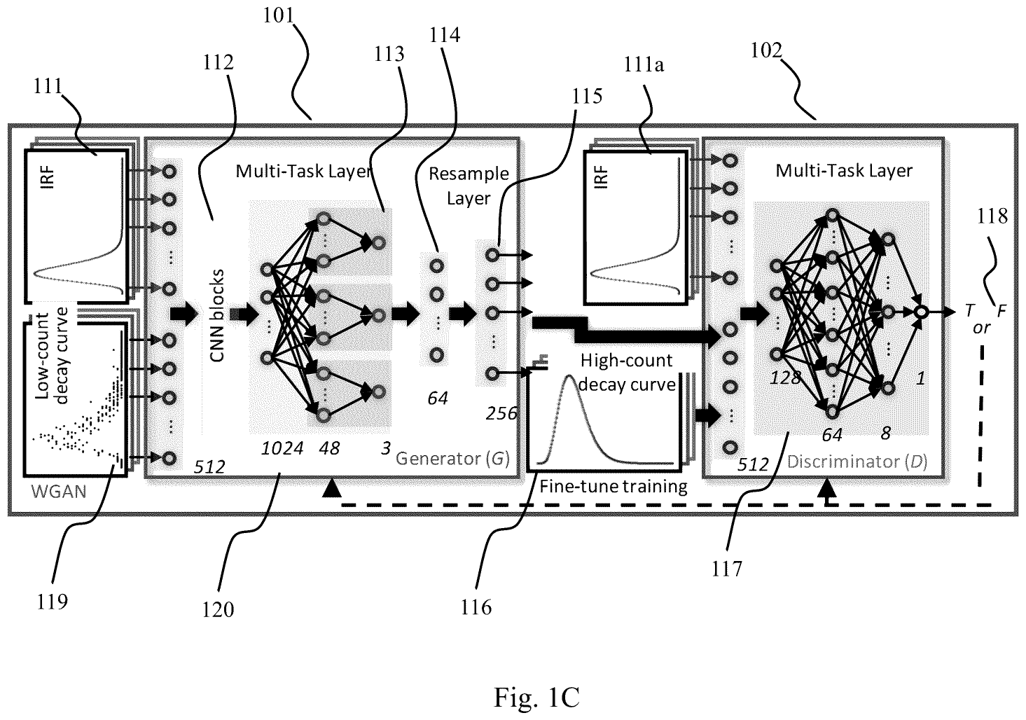

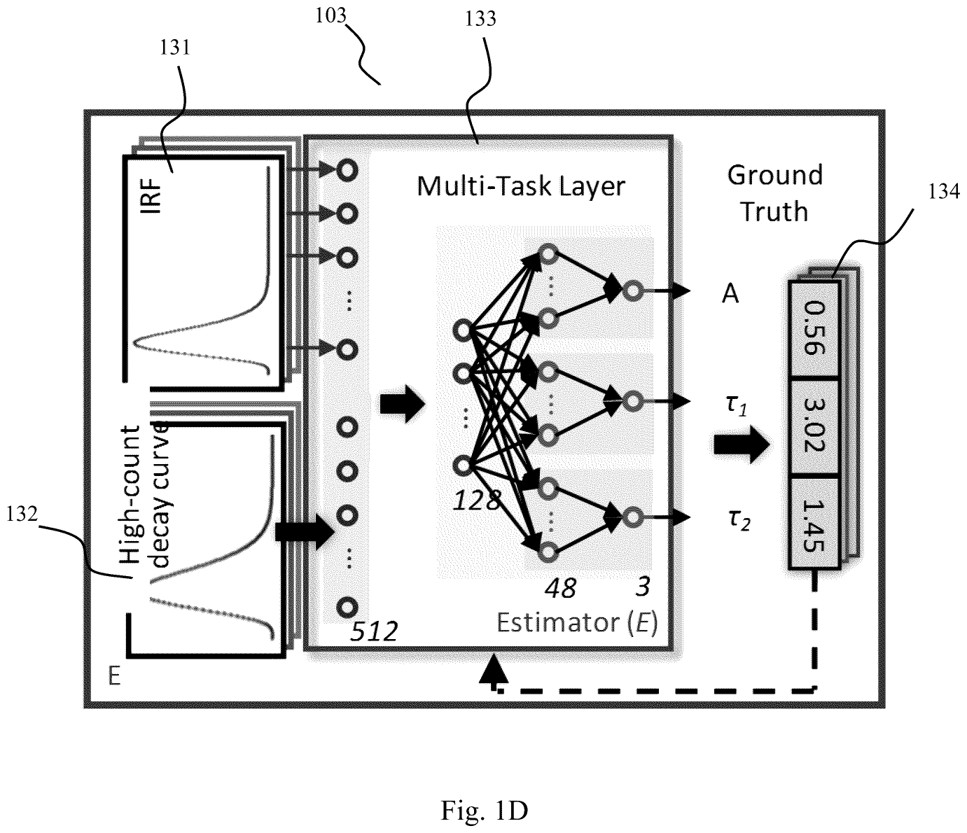

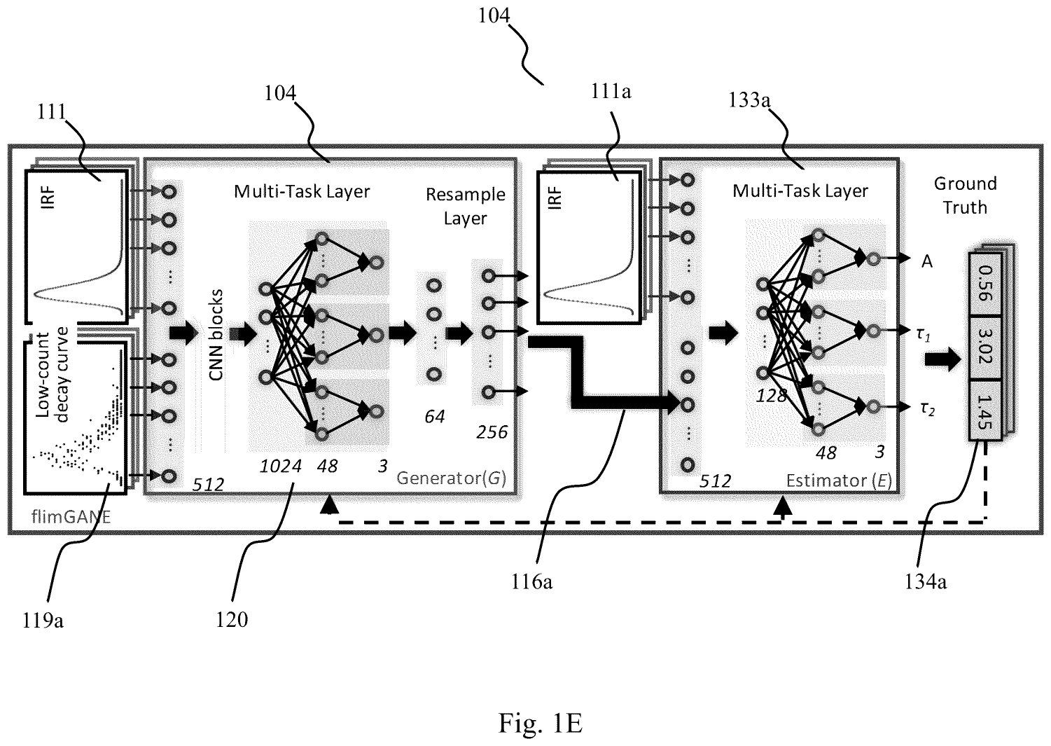

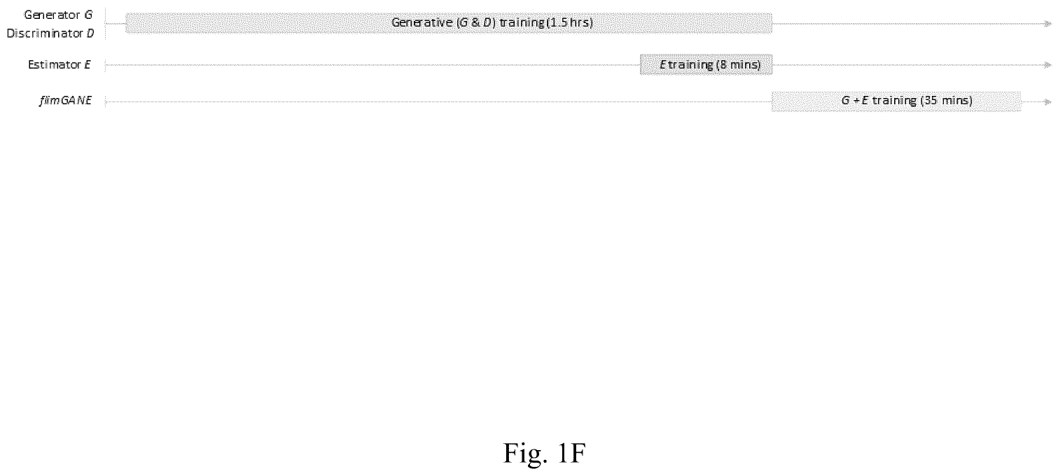

In one embodiment, the systems and methods disclosed herein relate to a deep learning model or neural network, for example a generative adversarial network (GAN). In the disclosed GAN framework, two sub-models are trained simultaneously—a generative network which enhances the input noisy fluorescence decay histogram, and a discriminative network which returns an adversarial loss to the quality-enhanced fluorescence decay, as illustrated in FIG. 1A. In one embodiment, cost functions for generative, G_{cost}, and discriminative models, D_{cost}, were set to:

$$\begin{matrix}{G}_{cost} = \frac{1}{n} {\sum }_{i = 1}^{n} log ( 1 - D ( G ( {z}_{i} ) ) ) & Equation 1 \\ {D}_{cost} = \frac{1}{n} {\sum }_{i = 1}^{n} ( log ( D ( {x}_{i} ) ) + log ( 1 - D ( G ( {z}_{i} ) ) ) ) & Equation 2\end{matrix}$$

where zᵢ represents the normalized low-photon-count fluorescence decay histogram, and xᵢ is the normalized ground-truth fluorescence decay histogram. G(z) is the normalized ground-truth mimicking histogram (Gₒᵤₜₚᵤₜ), and D(x) represents the probability that x came from the ground-truth fluorescence decay histogram rather than Gₒᵤₜₚᵤₜ.

In one embodiment, to improve the generative model performance, the Wasserstein generative adversarial network (WGAN) is used to convert a low-count histogram into a high-count histogram. The cost function for generative and adversarial WGAN model is:

$$\begin{matrix}{G}_{cost} = - \frac{1}{n} {\sum }_{i = 1}^{n} f ( G ( {z}_{i} ) ) & Equation 3 \\ {D}_{cost} = \frac{1}{n} {\sum }_{i = 1}^{n} ( f ( {x}_{i} ) + f ( G ( {z}_{i} ) ) ) & Equation 4\end{matrix}$$

where f(x) is a 1-Lipshitz function. A higher value of D output refers to the ground-truth data; while a lower value refers to the low-photon-count histogram. This modification of loss function helps to stabilize the training schedule and ensure that training process can lead the deep learning model to converging.

The structure one embodiment of a generative network is shown in FIG. 1B, which includes a convolution block, a multi-task layer (n=3), and a decoding layer explicitly and a residual block implicitly. Inside the residual block, the convolution block comprises two convolution layers and pooling layers followed by a flatten layer, within which it performs

y=ReLU[Conv{ReLU[Conv{Concat(x_{1:256},x_{256:512})}]}] Equation 5

where x represents the input of the generative model, normalized low-photon-count fluorescence decay histogram and corresponding instrument response function (IRF), y is the output of the convolutional block. Concat( ) is the concatenation operation of two inputs. Cony{ } is the convolution operation, ReLU [ ] is the rectified linear unit activation function,

ReLU[x]=x⁺=max(0,x) Equation 6

In one embodiment, the dimension of the output of each ReLU activation function is reduced by AveragePooling layer. Then a multi-task neural network with hard parameter sharing converts the high dimensional flattened output into three tasks, and each task corresponds to each lifetime parameter (for example, bi-exponential decay model). The last network, decoding layer, termed multilayer perceptron with the activation functions as tanh( ) to force the range of the output to lie between −1 and 1, maps the 3 tasks into 256 channels of output that together correspond to the fluorescence decay histogram. Instead of learning a direct mapping toward a ground-truth fluorescence decay histogram, the process is reframed as a residual learning framework by introducing a residual connection between one of the inputs, a normalized low-photon-count decay histogram, and the model's output.

In one embodiment, the structure of the discriminative model comprises a densely connected neural network with 128 nodes for incoming high-count decay histogram input. The output of the densely connected neural network may be fed into other densely connected neural networks with 64, 8, and 1 node. All layers except the last one has a sigmoid activation function, whose output is the probability (between 0 and 1) of a fluorescence decay histogram being a high-count decay histogram (ground truth), defined as

$$sigmoid ( x ) = \frac{1}{1 + {e}^{- x}} \qquad Equation 7$$

The last layer has the linear activation function to output the score corresponding to the input histogram fed into the discriminator.

In one embodiment, the issues of low photon count and IRF are addressed in part by changing the input data used to train the model. Existing systems generally use the Poisson process to simulate histograms. However, this method does not assign the exact number of photon counts in the histogram. In one embodiment of the disclosed system, a Monte Carlo (MC) based approach is used to generate fluorescence lifetime decay histograms in-silico. MC simulation allows the user to assign an exact number of photons to the synthetic data.

In one embodiment, the disclosed methods and systems are configured to produce FLIM images in real-time, and/or to produce 3D FLIM images. In one embodiment, the disclosed methods and systems may be configured to perform single-molecule detection and even super-resolution FLIM.

In various embodiments, different methods of training the neural network may be used. In one embodiment, the model may be trained with hundreds of thousands of synthetic histograms and corresponding lifetime parameters for a long training time, for example up to 7 hours. With this training method, it is expected that the model will provide a lifetime estimate given an input decay histogram. In another embodiment, the model may be trained with image batches (for example, 512 pixels×512 pixels×256 bins×n batches). In this case, the model will directly generate a FLIM image (512 pixels×512 pixels) given the input with the dimension as (512 pixels×512 pixels×256 bins). In the first training procedure, flimGANE may be configured to produce either a single-pixel lifetime estimate or multi-pixel lifetime estimates. With the second training procedure, data from adjacent pixels or adjacent batches may be used to further improve the details of the FLIM image, achieving a super-resolution FLIM with high speed.

One aspect of the disclosed system is a generative adversarial network (GAN) comprising a generator, a discriminator, and an estimator, configured to output calculated high-photon-count histogram curves from low-photon-count histogram curves.

A schematic structure of a disclosed system is shown in FIG. 1A-FIG. 1E. With reference to FIG. 1A, a method of the disclosed system includes using a generator 101, a discriminator 102, and an estimator 103, to train the finished neural network 104.

With reference to FIG. 1B, a detail view of the generator 101 and estimator 102 is shown. In the generator 101 (WGAN-G), the inputs, IRF 111 and low-count fluorescence decay histogram 119 are fed into a generator network 120 including CNN blocks 112 followed by a multi-task layer 113 and resample layers 114 and 115 to construct a high-count fluorescence decay histogram with a higher SNR 116. The generator network 120 functions by generating synthetic high-count decay curves based on the inputs. When untrained, a generative network's output has very low correlation with the network's input, and so at the beginning of a training process, high-count decay curve 116 is not expected to be an accurate enhancement of low-count decay curve 119.

As understood herein, in one embodiment a “low-count” decay curve is a fluorescence decay histogram having a photon count of 200 or less. In various embodiments, a low-count decay curve may have a photon count of 400 or less, 300 or less, 250 or less, 180 or less, 160 or less, 150 or less, 130 or less, 125 or less, 100 or less, 80 or less, 60 or less, 50 or less, or the like. In one embodiment, a “high-count” decay curve is a fluorescence decay histogram having a photon count of 1000 or more, 1200 or more, 1250 or more, 1400 or more, 1500 or more, 1800 or more, or 2000 or more.

The discriminator network 117 is used to train the generator network 120. The discriminator network 117 takes inputs as a high-count decay curve 116 and instrument response function 111a. The discriminator network is trained to recognize a high-count decay curve as valid (true) or not valid (false) in Boolean output 118. In one embodiment, the discriminator network 117 is trained first on real and fake high-count decay curves, then later applied to the output of the generative network 120 in order to provide feedback. In one embodiment, the discriminator network 117 and the generator network 120 are trained simultaneously. The output 118 of discriminator network 117 may be fed back into one or both of discriminator network 117 and generator network 120 in order to provide feedback and training to one or both networks.

As the generator network 120 is trained, it is able to produce high-count decay curves 116 from low-count decay curves 119 with increasing accuracy. Once fully trained, the generator network's output 116 is treated as a true representation of a high-count decay curve that would have been obtained from the sample measured by the low-count decay curve 119 had sampling been allowed to continue. In one embodiment, this threshold is deemed to be met when the validation loss no longer decreases.

In one embodiment, the quality index (QI) for the synthetic decay histogram was calculated by first assuming the amount of signals is the total photon counts, and the amount of noise is the deviation of synthetic decay histogram from the real decay histogram. The relationship can be described as the following equations:

$$QI = \frac{S}{{Σ}_{i} \vert {y}_{i} - {r}_{i} \vert} \qquad Equation 8$$

where S represents the total photons of the fluorescence decay histogram, yᵢ is the synthetic decay histogram on i^{th} bin, and rᵢ represents the real decay histogram on i^{th} bin.

In some embodiments, a generative model may further include one or more additional techniques, including but not limited to the use of a gradient penalty (e.g. WGAN-GP), sequence generation framework, and context-aware learning.

With reference to FIG. 1D, a schematic diagram of an estimator 103 is shown. The estimator 103 accepts the IRF 131 and a high-count decay curve 132 as its inputs, and uses a multi-task layer 133 to calculate estimated lifetime parameters 134 of the input high-count decay curve 132. The estimator may be trained against a ground truth, for example lifetime parameters calculated using a different method. Once trained, estimator 103 is able to calculate the lifetime parameters quickly and accurately.

In one embodiment, the structure of the estimative model comprises two densely connected neural networks with 64 nodes for incoming instrument response function input and high-count decay histogram input. The two outputs are first concatenated by a concatenation layer. The output of the Concatenate layer is fed into the multi-task neural network 133 (n=3) with hard parameter sharing, and a multilayer perceptron with a single hidden layer, whose output is the corresponding fluorescence lifetime parameters. The loss function for E to be trained is defined as follows:

$${E}_{loss} = \frac{1}{n} {\sum }_{i = 1}^{n} {( {y}_{i} - {\hat{y}}_{i} )}^{2} \qquad Equation 9$$

where yᵢ, ŷᵢ represent the predicted and the ground-truth lifetime parameters, respectively.

With reference to FIG. 1E, a diagram of an implemented flimGANE system 104 is shown incorporating trained networks from earlier steps. The implemented system includes a trained generator network 120 which takes as its inputs a measured low-count decay curve 119a and an IRF 111. The output of the trained generator network 120 is a synthetic high-count decay curve 116a which, due to the training of the generative network, is an adequate representation of the high-count decay curve which would have been measured with additional measurement time. The synthetic high-count decay curve 116a and the IRF 111a are provided to the trained estimator network 133a, which calculates the fluorescence lifetime parameters 134a as its output based on the synthetic decay curve.

In one embodiment, a method of the present disclosure is directed to time-shifting a fluorescence lifetime decay histogram to compensate for environmental and instrument response variations.

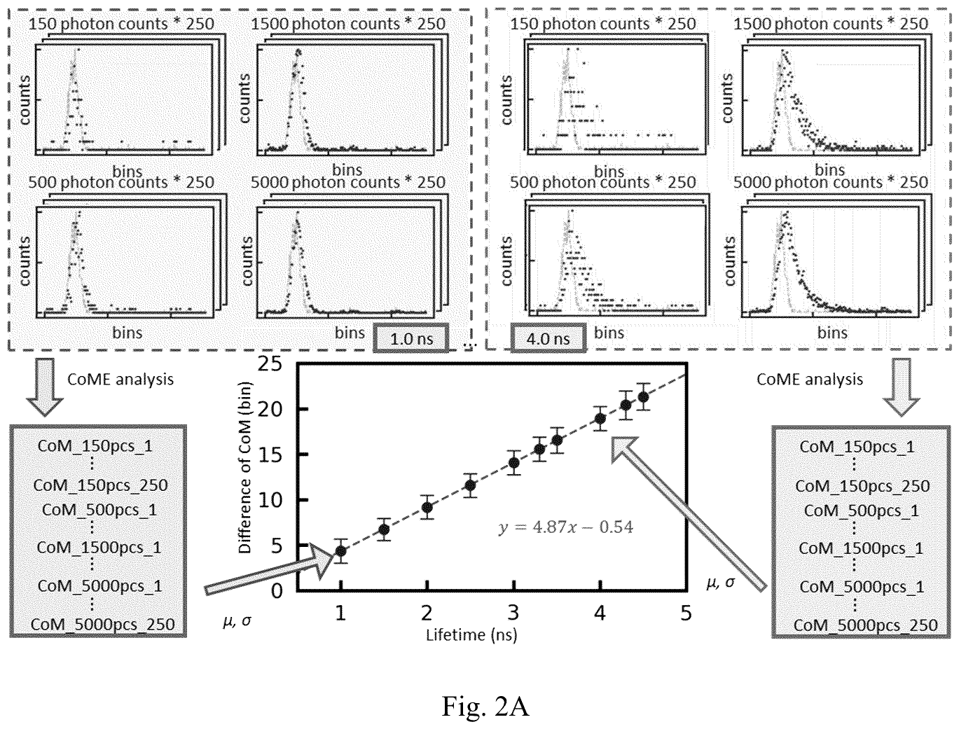

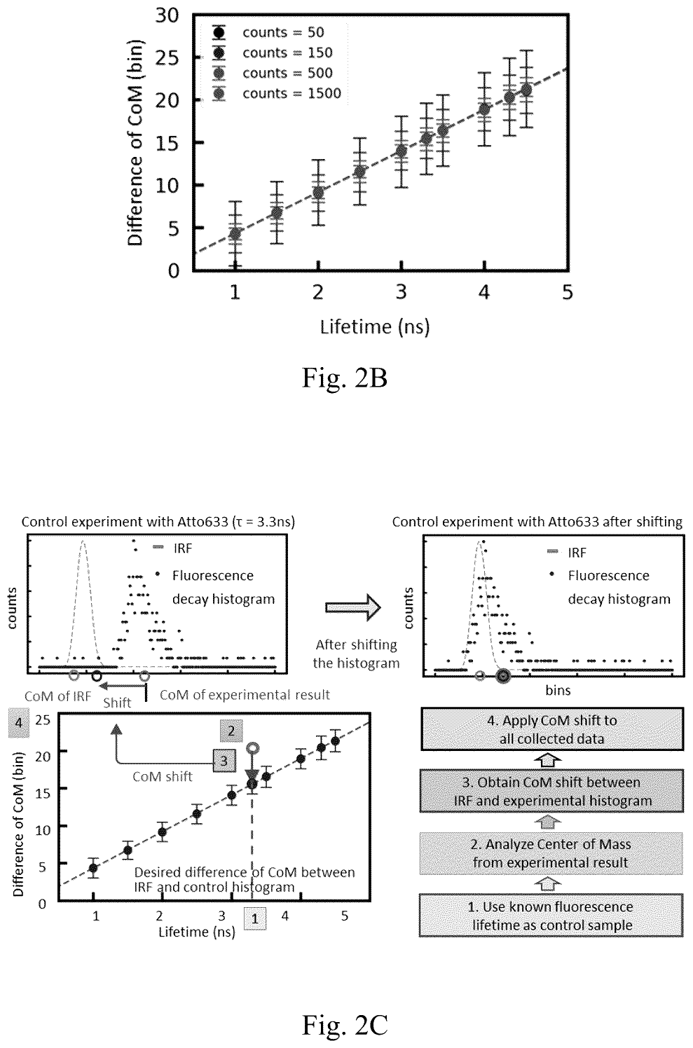

With reference to FIG. 2A, in order to calibrate the shift between an IRF and a fluorescence decay histogram, a calibration line or linear calibration relationship may be calculated to determine a transform function for time-shifting a fluorescence decay histogram depending on the fluorescence lifetime being measured. In order to generate sufficient data to determine the relationship, Monte Carlo simulations may be used in one embodiment to generate a quantity of synthetic decay histograms for each lifetime value. In one embodiment, at least 100 synthetic decay histograms are generated for each lifetime value. In other embodiments, at least 500, at least 1000, at least 2000, at least 5000, or at least 10000 synthetic decay histograms are generated for each lifetime value. Synthetic histograms may be generated using any suitable means and are not limited to Monte Carlo simulations. Other suitable methods are directly sampling from the exponential decay and adding with background noise (white noise) or Poisson process simulation. Second, a Center of Mass analysis may be performed on each decay histogram and IRF in order to determine the center of mass of each curve. The centers of mass are calculated in one embodiment using Equation 10 below where h(xᵢ) is the decay histogram value acquired from the experiment at the corresponding bin xᵢ. All analysis results may then be compared, with the mean value at each fluorescence lifetime used as a data point for calculating the relationship, which in some embodiments is a linear regression. As shown in FIG. 2A, the mathematical relationship between the differences in the COM of the fluorescence lifetime histogram and the IRF may be used to calculate a time shift to correct for the instrument response function across different lifetime curves.

$$CoM = \frac{Σ {x}_{i} h ( {x}_{i} )}{Σ h ( {x}_{i} )} \qquad Equation 10$$

Compared with several deep learning architectures (Multilayer Perceptrons (MLP) for classification/regression prediction, Convolutional Neural Networks (CNN) for image classification, Recurrent Neural Networks (RNN) for time series forecasting), GANs have been shown to (1) generate data similar to real data and (2) learn from messy and complicated distributions of data. Recently, a GAN was demonstrated to transform an acquired low-resolution image into a high-resolution one.

Furthermore, the disclosed system utilizing a WGAN provides fast, fit-free, and accurate lifetime image generation in fluorescence lifetime imaging microscopy without the need for thousands of time-tagged photons. In one embodiment, a deep neural network was trained using a WGAN model to transform an acquired low-count decay histogram into a high-count one using matched pairs of experimentally acquired low-count and synthetic decay histograms. The estimator model then mapped the resulting decay histograms into the lifetime values of interest. The success of this approach was a result of a highly accurate resampling process between the lower-count and corresponding higher-count decay histograms, allowing the network to focus on the task of lifetime estimation of a previously unseen input decay histogram. In one embodiment, the trained neural network remained fixed to rapidly generate batches of FLIM images in, for example, 80s (2,800 times faster than a typical MLE analysis time of 66 hours) for an image size of 512×512 pixels without using a graphics processing unit (GPU). In one embodiment, the trained neural network was continuously trained to further optimize the deep network through fine-tuning. In one embodiment, the inference of the network was non-iterative and did not require a parameter search to perfect its performance.

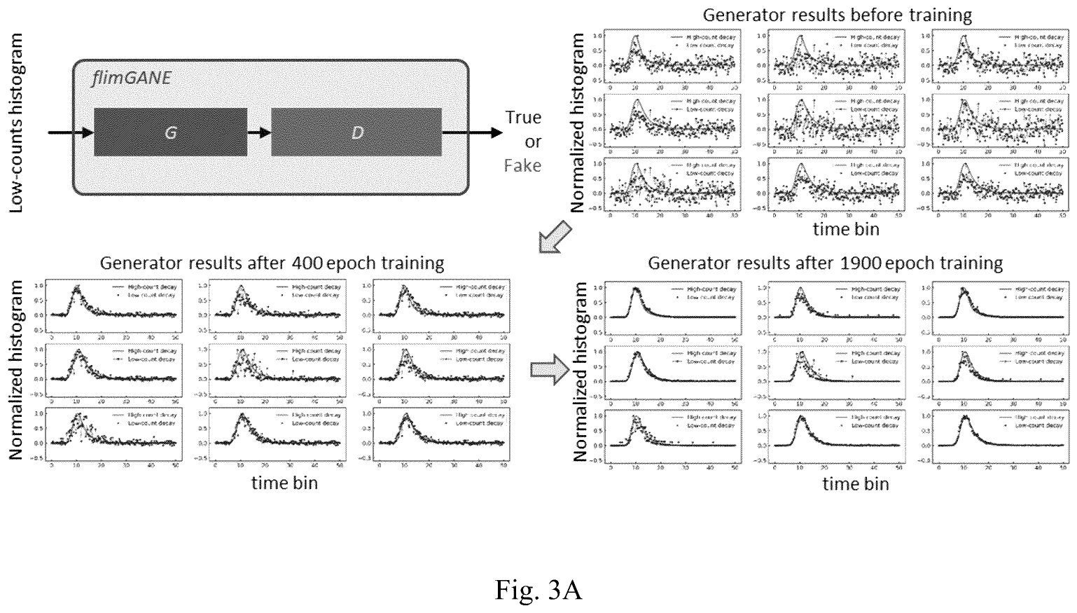

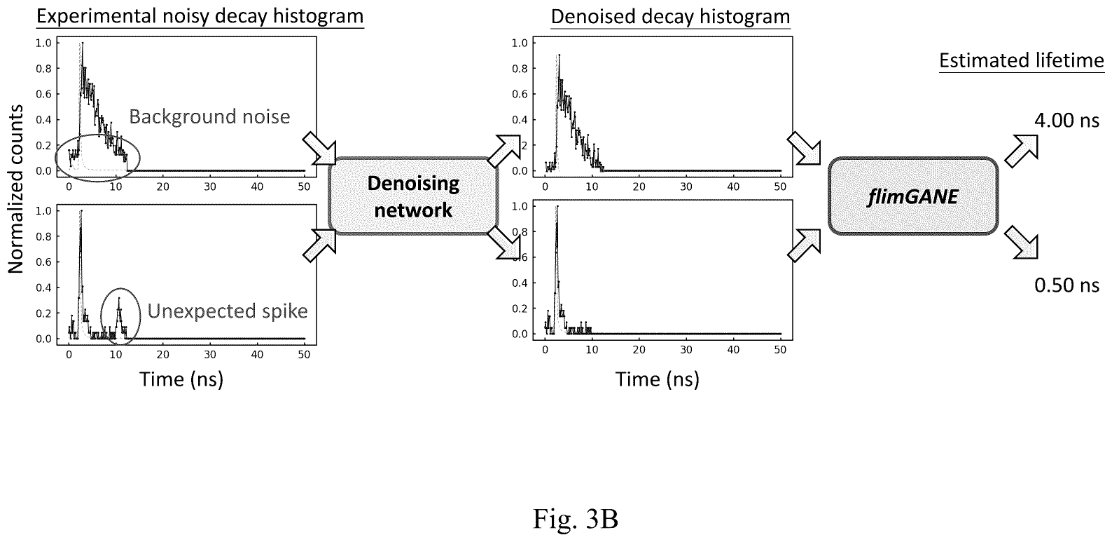

In one embodiment, the disclosed deep learning approach improved the fluorescence decay histogram QI (FIG. 3A). In existing systems, the accuracy of lifetime estimation is fundamentally limited by the quality of the decay histogram. The lack of sufficient photons recorded can be addressed based on the statistical inference. For example, maximum likelihood estimation estimates the parameters by maximizing the likelihood function governed by lifetime values. In practice, however, this was a challenging task and the success of the MLE method was dependent on the QI and a priori information regarding the sample. The presented deep-learning-based approach learned to statistically separate noise patterns from the fluorescence decay profile of the sample, helping to improve QI for further analysis.

Moreover, the disclosed system generates real-time, non-photobleaching FLIM with low available photon budgets (FIG. 1A). The disclosed systems and methods also produced accurate fluorescence lifetime estimates from low-count decay histograms under low QI conditions (FIG. 3A).

The disclosed system is advantageously able to transform low-count decay histograms with low QI into higher-count decay histograms with better QI for further applications. It enhances structure representation in FLIM images, provides an unbiased lifetime measurement for identifying different populations of fluorescence lifetime-based beads, and is completely compatible with a variety of fluorescence lifetime imaging devices.

The disclosed GAN-based framework accurately registers the IRF to the recorded fluorescence decay histograms. The disclosed multi-stage registration process produces a pixel-to-pixel transformation and was used as a resampling algorithm for the network to quantify lifetime values, while avoiding the decay shift of the input histograms, which in turn significantly reduced potential artifacts. The disclosed Center of Mass (CoM) mathematical method addressed this issue. In some embodiments, when the model was trained with more data and iterations, the model achieved analysis of fluorescence decay histograms with various species. While in some existing systems, FLIM images are generated one pixel at a time, in one embodiment, the disclosed system is configured to generate a whole FLIM image at once.

In some embodiments, transfer learning and fine-tuning algorithms are included to continuously optimize the deep learning model. The data and model may be used to calculate the number of components contained in the fluorescence decay histogram. The disclosed systems and methods are in some embodiments applied to the study of biological phenomena (e.g., stem cell studies, molecular diagnostics, molecular imaging, cellular metabolism, inflammatory processes and detecting the presence of cancer cells and neurodegenerative diseases) at the molecular level.

As disclosed herein, systems including a GAN may be configured to generate data similar to real data and additionally learn from messy and/or complex distributions of data. A GAN-based framework may be used as a “fluorescence lifetime decoder” that can generate accurate lifetime estimates with varying photon counts. The disclosed GAN model correctly calculated fluorescence lifetime at low photon counts (˜50).

In some embodiments, a system or method as disclosed herein may comprise a denoising network, for example configured as a pre-processing step to remove noise from experimentally measured data and produce denoised decay histograms. An exemplary schematic diagram of a denoising network is shown in FIG. 3B. In one embodiment, the denoising network takes as its input measured data which may or may not contain background noise, jitter, or any other type of noise. The denoising network may provide as an output a fluorescence decay histogram, for example a low-count fluorescence decay histogram, in which the noise has been reduced and therefore the signal-to-noise ratio increased. The denoised fluorescence decay histogram may then be used as an input low-count decay histogram to a flimGANE system as disclosed herein.

In some embodiments, a denoising network may be trained using a plurality of noisy low- or high-count decay histograms acquired experimentally, and/or a plurality of low-noise, artificial fluorescence decay histograms generated by a Monte Carlo simulation as described above.

A deep-learning framework was built, referred to herein as flimGANE, that achieved fast, fit-free, and accurate lifetime image generation without the need for thousands of time-tagged photons (FIG. 1A). Using this approach, low-count decay histograms (having low QI) were converted to high-count decay histograms (having high QI), as shown in FIG. 3A.

While ML- or DL-based FLIM offers the advantage of high-speed analysis (e.g. ANN-FLIM and FLI-Net), they neither provide the capability for lifetime estimation at low photon counts nor consider the instrument response function (IRF) effect. A representative comparison of different methods is summarized in Table 1.

TABLE 1

| | | Low- | | |
|---|---|---|---|---|
| | | photon | | |
| | | counts | | Modulated |
| | | (100) | Consider | light |
| Analysis | | lifetime | IRF | source |
| Method | Processing time per pixel | estimate | effect | required |
| TD_LSE | Slow (82.4 ms) | No | Yes | No |
| TD_MLE | Slow (906.37 ms) | Yes | Yes | No |
| DFD_LSE | Medium (3.94 ms) | No | Yes | Yes |
| ANN-FLIM | Fast (0.22 ms) | No | No | No |
| FLI-Net | Fast (0.75 sec) | No | Yes | No |
| flimGANE | Fast (0.32 ms) | Yes | Yes | No |
| | Still under developing. | | | |
| | Goal: 0.006 ms per pixel | | | |
| | in the future version. | | | |

With reference to Table 1, the processing time represents the time spent for an image with 512*512 pixels. The flimGANE processing time of 0.32 ms per pixel was measured based on an old personal computer. Future work: Incorporating CNN concepts, we envision flimGANE can be 5-fold faster (0.06 ms per pixel). Furthermore, with the integration of GPU, we expect the processing speed can be further increased by 10-fold faster (0.006 ms per pixel).

The disclosed flimGANE model provides more accurate and faster lifetime analysis compared to other methods. The imaging output from flimGANE matches very well with the theoretical FLIM even at low photon counts. In general, to evaluate image quality with the ground truth, mean squared error, MSE, and SSIM were used. A better match lowers the MSE and raises SSIM.

Although certain exemplary embodiments of systems and methods have been presented herein as related to a particular application, it is understood that the disclosed examples are not limiting, and that one skilled in the art would understand that the systems and methods disclosed herein may be used to improve signal quality or image fidelity in a wide variety of applications, including but not limited to 3D FLIM, real-time 3D FLIM, super-resolution FLIM to illustrate more detailed information about the structure of a sample or in some embodiments single-molecule FLIM, live cell Forster Resonance Energy Transfer (FRET) imaging, lifetime-based analysis in flow cytometry, or lifetime-based analysis for two-photon microscopy. In one embodiment, the systems and methods disclosed herein may be used in biomarker identification, for example identifying the size difference of exosomes, identifying leukemia cells by investigating the lifetime shift of NADH, or identifying circulating tumor cells from biopsy, exosomes, and other biomarkers to determine additional information about a cancer diagnosis. The systems and methods described herein may be particularly useful for working within the constraints of low-photon limits for live-cell imaging.

In some embodiments, systems and methods disclosed herein may be used with lifetime-encoded beads for multi-species lifetime imaging with fewer photon counts. In some embodiments, systems and methods disclosed herein may be used for time-resolved mesoscopic imaging of a whole organism using FastFLIM, or frequency domain phosphorescence lifetime imaging measurements using FastFLIM and multi-pulse excitation.

In some embodiments, a method may include the step of clustering pixels into one or more groups using clustering algorithms, including but not limited to the K-means algorithm. With multiple pixels grouped this way into a single “virtual pixel”, multiple pixels, each having fewer than 50 photons, may be analyzed instead as one virtual pixel with enough photons for accurate lifetime analysis by summing the data within the group. In some embodiments, clustering may be used for imaging segmentation.

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

Experimental Setup

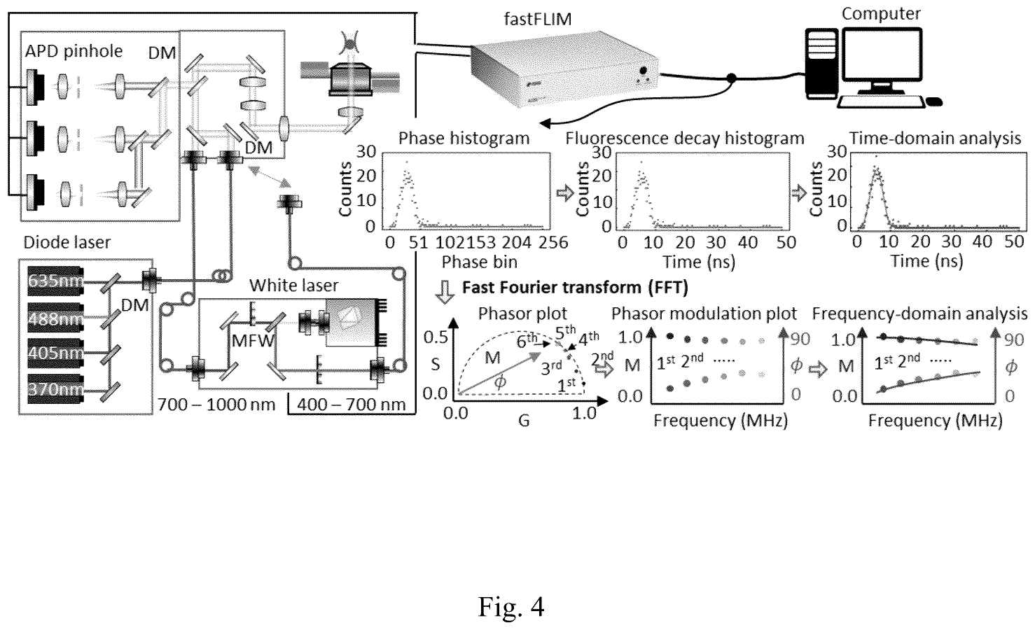

With reference to FIG. 4, the FLIM system used in the presented examples was equipped with diode lasers providing 370 nm, 405 nm, 488 nm, and 635 nm lines and a supercontinuum white laser providing a wavelength within 400-1000 nm. All the laser lines combined in Alba v5 passed a multi-band dichroic mirror to excite samples. Fluorescence emission light came back along the same path to the multi-band dichroic mirror, and was directed into 3 detectors, where each detector had its own pinhole. An inverted microscope with 60×, NA 1.2 water objective is used. An automatic stage with motorized Z control was used. The photon counts were acquired with a fastFLIM unit to build up the phase histogram. The laser repetition period was 50 ns, and was divided into 256 bins. The acquired phase histogram was translated into a phasor plot with multiple harmonic frequencies using a fast Fourier transform (FFT). From such a phasor plot, modulation factor (M) and phase shift (Φ) at each harmonic frequency was obtained, which were then fitted with a least-squares estimator to generate a lifetime at each pixel.

Before imaging biological samples, it was necessary to calibrate the FLIM system using a fluorescence lifetime standard. The fluorescence lifetime for many fluorophores has been established under standard conditions, and any of these probes can be used for the calibration of the FLIM system. Since the fluorescence lifetime of a fluorophore is sensitive to its environment, it is critical to prepare the standards according to the conditions specified in the literature, including the solvent and the pH. It is also important to choose a standard fluorophore with excitation, emission, and fluorescence lifetime properties that are similar to those of the fluorophore used in the biological samples. For example, the dye, Coumarin 6, dissolved in ethanol (peak excitation and emission of 460 and 505 nm, respectively), with a reference lifetime of ˜2.5 ns, is often used as the calibration standard for the CFPs. It is important to note that if the excitation wavelength is changed, it is necessary to recalibrate with another appropriate lifetime standard.

A temporal shift occurs when a measurement is biased toward shorter or longer arrival times due to noise. To characterize the temporal shift, the most common method is to perform model fitting with time shift as the additional parameter. During the process of curve fitting, the algorithms take temporal shift into consideration to find the optimal value for both lifetime parameters and time shift. However, significant processing time may be necessary to obtain the optimal time shift parameter. Disclosed herein is a new analysis method, Center of Mass Evaluation (CoME), to quantify the time shift parameter without the time-consuming curve fitting process. The mass center of the histogram, also known as the expected value of the histogram, was determined by Equation 10 above, where h(xᵢ) is the fluorescence decay histogram acquired from the experiment at the corresponding bin xᵢ.

For certain lifetimes, the difference of CoM between IRF and the fluorescence decay histogram should be the same. To verify this hypothesis, 250 simulated decay histograms were generated with photon counts of 150, 500, 1500, 5000 for various fluorescence lifetime values. The mean and standard deviation were then calculated of the differences of CoM. FIG. 2B shows the calibration line for the distance of CoM between IRF and fluorescence decay histogram. Such a calibration line is employed to determine the amount of the temporal shift.

To eliminate the “temporal shift” effect that may cause inaccurate lifetime estimation, this parameter was obtained using a CoM analysis discussed above with the control experiment and then employed to calibrate the measurement for each pixel. With IRF and the calibrated fluorescence decay histogram as model inputs, flimGANE calculated two lifetime components and its relative ratio for each pixel, forming the FLIM image accurately and rapidly.

Calibrating the phasor plot is a pre-processing step for digital frequency domain fitting. The DFD-FLIM data measurements at each pixel location are composed of both the phase delay (ω) and the amplitude modulation ratio (m). The DFD-FLIM data at each pixel can be mapped to a single point called “phasor” in the phasor plot through a transform defined below, where ω is the modulation frequency, g(ω) and s(ω) represent the values at the two coordinates (g(ω), s(ω)) of the phasor plot.

g(ω)=m cos(φ)

s(ω)=m sin(φ) Equation 11

In order to establish the correct scale for phasor analysis, the coordinates of the phasor plot need to be calibrated, for example by using a standard sample of known lifetime. This will include the calibration of the IRF and the background noise. In DFD-FLIM, this is done during experimental calibration prior to data acquisition. There is no need to measure the IRF explicitly. The calibration procedure subtracts the noise and divides denoised data by the IRF to reveal the true fluorescent emission component(s). In time domain FLIM, a directly recorded IRF for the zero lifetime (scatter) will be measured. The IRF will then be used for lifetime fitting, (with a convolution), and model analysis.

The present example demonstrates a new fluorescence lifetime imaging method based on Generative Adversarial Network Estimation (referred to herein as flimGANE) that can generate fast, fit-free, precise and high-quality FLIM images even under low-light conditions. While GAN-based algorithms have recently drawn much attention for inferring photo-realistic natural images, they have not been used to generate high-quality FLIM images based on the fluorescence decays collected by a laser scanning confocal microscope. With reference to FIG. 1A, The disclosed flimGANE method is adapted from the Wasserstein GAN algorithm (WGAN), where the generator G is trained to produce an “artificial” high-photon-count fluorescence decay histogram based on a low-photon-count input, while the discriminator D distinguishes the artificial decay histogram from the ground truth. The ground truth used may be a simulated dataset or a decay histogram collected under strong excitation. As a minimax two-player game, the training procedure for G is to maximize the probability of D making a mistake, eventually leading to the production of very realistic, artificial high-photon-count decay histograms that can be used to generate a high-quality FLIM image. Using a well-trained generator G and an estimator E, a low-quality decay histogram can be reliably mapped to a high-quality histogram, and eventually to the three lifetime parameters (α₁, τ₁, and τ₂) within 0.32 ms/pixel. Without the need to do any curve fitting based on initial guesses, the disclosed flimGANE method is 258 times faster than the time-domain least-squares estimation method (TD_LSE) and 2,800 times faster than the time-domain maximum likelihood estimation method (TD_MLE) in generating a 512×512 FLIM image. While almost all commercial FLIM analysis tools are based on TD_LSE, using the least-squares estimator to analyze Poisson-distributed data is known to lead to biases, making TD_MLE the gold standard for FLIM analysis by many researchers. The disclosed flimGANE method can provide similar FLIM image quality as the TD_MLE method, but much faster.

Overcoming a number of hardware limitations in the classical analog frequency domain approach, the digital frequency domain (DFD) lifetime measurement method has substantially increased the FLIM analysis speed. The acquired DFD data at each pixel, termed a cross-correlation phase histogram, can lead to a phasor plot with multiple harmonic frequencies. From such a phasor plot, the modulation factor and phase shift at each harmonic frequency can be obtained, which are then fitted with a least-squares estimator (LSE) to generate a lifetime at each pixel (termed the DFD-LSE method). The disclosed flimGANE method not only runs nearly 12 times faster than the DFD-LSE method but also produces more accurate quantitative results and sharper structural images of Convallaria and live HeLa cells. Whereas the lowest number of photons needed for reliable estimation of a fluorescence lifetime by TD-MLE is about 100 photons, flimGANE performs consistently well with a photon count as low as 50 per pixel in simulations. Moreover, flimGANE improves the energy transfer efficiency estimate of a glucose FRET sensor, leading to a more accurate glucose concentration measurement in live HeLa cells. Providing both efficiency and reliability in analyzing low-photon-count decays, the disclosed flimGANE method represents an important step forward in achieving real-time FLIM.

Based on the Wasserstein GAN framework, flimGANE is configured to analyze one- or two-component fluorescence decays under photon-starved conditions. With reference to FIG. 1B, there are two ways to generate a ground-truth lifetime histogram dataset for training G and D in flimGANE—either by creating a decay dataset using a Monte Carlo (MC) simulation or by acquiring an experimental dataset using standard organic dyes under high excitation power. The inputs of G are degraded data from ground truths, which can be obtained by running a simulation at a low emission rate or by collecting experimental data under low excitation power.

During training, the batch size was set as 32 on single GPU. Three-stage training was employed, with stage 1 being a generative model training stage, stage 2 being an estimative model training stage, and stage 3 being a flimGANE combination training stage. In the generative model training stage, the iteration count was set to 2,000. Within each iteration, ˜3% of training samples were randomly selected from the pool. The discriminative model was updated five times while the generative model was kept untrainable, then the generative model was updated once while keeping the discriminative model untrainable.

In the estimative model training stage, the iteration count was set to 500. Within each iteration, ˜18% samples (90% for training, 10% for validation) were randomly selected from the pool. The estimator model was then updated ten times. The aforementioned two training stages may in some embodiments be trained simultaneously and independently. Finally, in the flimGANE combination training stage, the generative model and estimative model were combined, and the resulting combined flimGANE system was fed with a randomly selected set of 10% of the training samples to update only the estimative model 100 times in each iteration, where the iteration count was set to 100. Both the generative model and the discriminative model were randomly initialized by a Glorot uniform initializer and optimized using the RMSprop optimizer with a starting learning rate of 5×10⁻⁵.

The final generative and discriminative models for each application disclosed herein were selected at approximately the 2000^{th} iteration, which took about 1.5 hours to train in the generative model training stage. The estimator model which mapped the ground-truth fluorescence decay histogram to lifetime values was initialized by the Glorot uniform initializer and optimized using Adam optimizer with a learning rate of 1×10⁻³. All the estimative models for specific applications were pre-trained for 500 iterations, which took ˜8 minutes to train in estimative model training stage. The generative models integrated with estimative models were then trained for 100 iterations, which took ˜35 minutes to train in the flimGANE combination training stage. Training without the discriminative loss and predictive cost can result in over-smoothed images, as the generative model optimizes only a specific group of statistical metrics. Therefore, the discriminator must in some embodiments be included to train the generative model well. A step-by-step training instruction and guideline, with several critical steps discussed and emphasized, is illustrated in FIG. 1C, FIG. 1D, FIG. 1E, and FIG. 1F.

As understood herein, SSIM is a method used for measuring the similarity between two images. In one embodiment, the SSIM was calculated by first smoothing two images with a Gaussian filter (σ=1.5 pixels). Then the SSIM index was obtained for each window of a pair of sub-images. It was calculated for square windows, centered at the same pixel (dx, dy) of two images. The length of a side of the square window was eleven pixels. The SSIM (x, y) was then obtained for two windows in two images (x, and y) as follows,

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad Equation 12$$

where, μₓ, μ_{y} are the average of pixel intensity of window x and y, σₓ, σ_{y}, σ_{xy} are standard deviation of window x and y, and covariance of two windows, c₁, and c₂ are (0.01×L)² and (0.03×L)², respectively, and L equals to the data range of the lifetime image. Then SSIM(x,y) was averaged over all the area. The average of SS/M, SSIM, was calculated and served as “SSIM” for each pair of images in this disclosure.

### Virtual Resampling of Fluorescence Decay Curve

The disclosed system was designed to analyze complex fluorescence decays without the need for thousands of photons via virtual resampling using a generative-adversarial network framework (FIG. 1A). FIG. 1A depicts a schematic representation of a deep learning framework for lifetime analysis. The generator section was used to transform an acquired decay curve into a higher-count one. It comprises two CNN blocks, each of which are made up of one convolutional layer followed by an average pooling layer of stride two. The CNN section was followed by a flatten layer. A multi-task layer then converted data into virtual lifetime parameters, followed by two fully connected layers. A skip connection was used to pass data between layers of the same level. The discriminator consisted of four fully connected layers. The estimator comprised a partially connected and a fully connected layer followed by a multi-task layer to map the high-count decay curve into lifetime parameters.

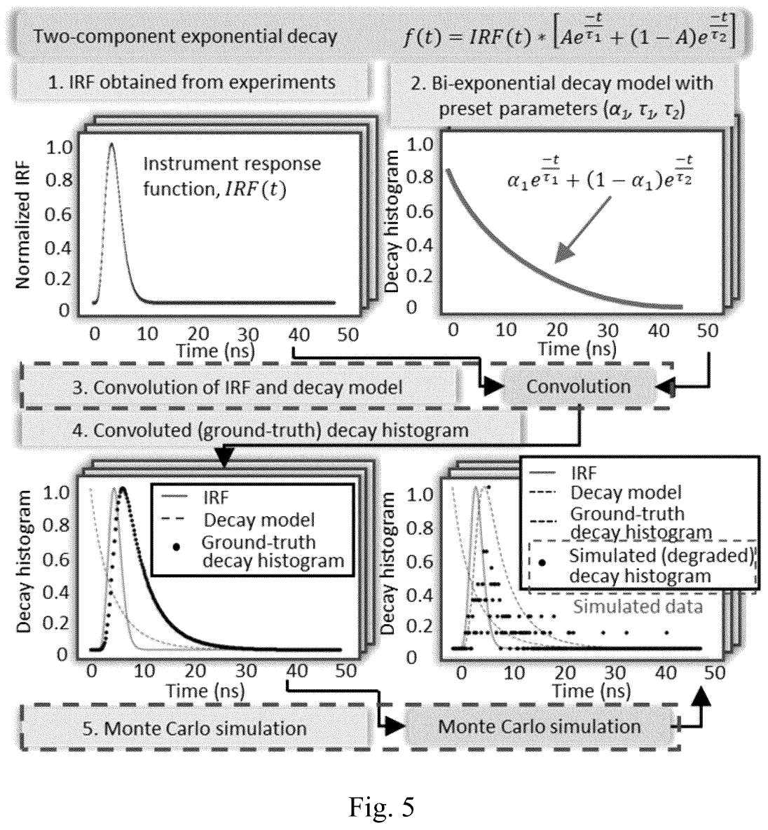

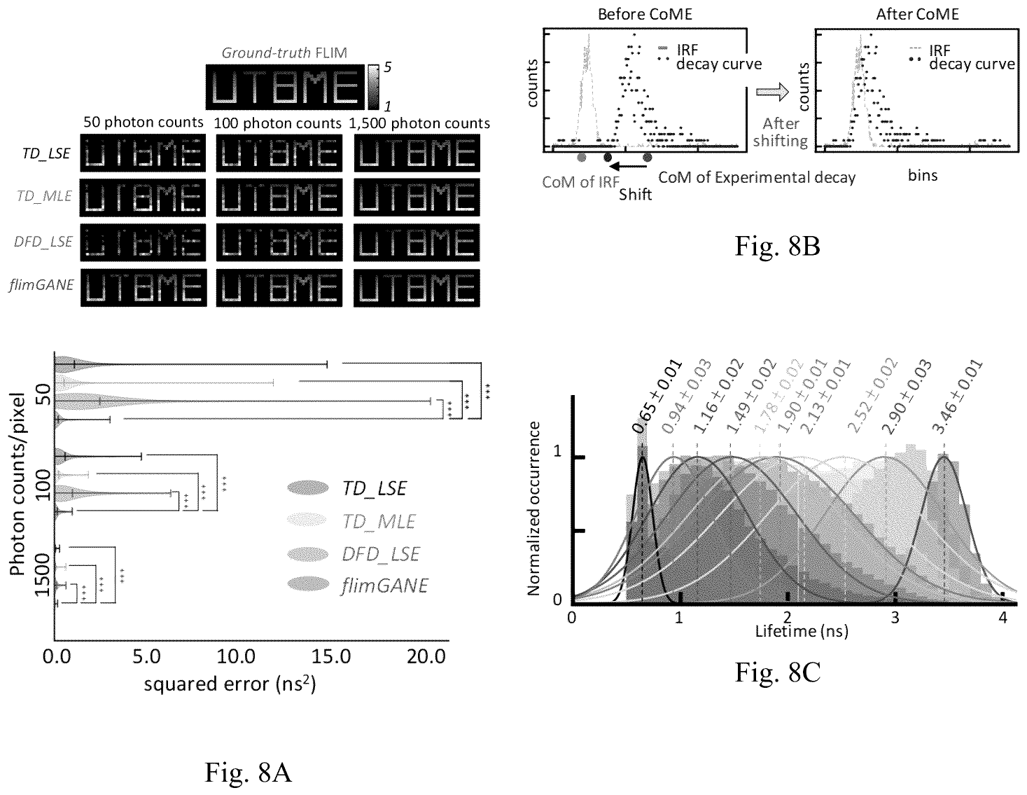

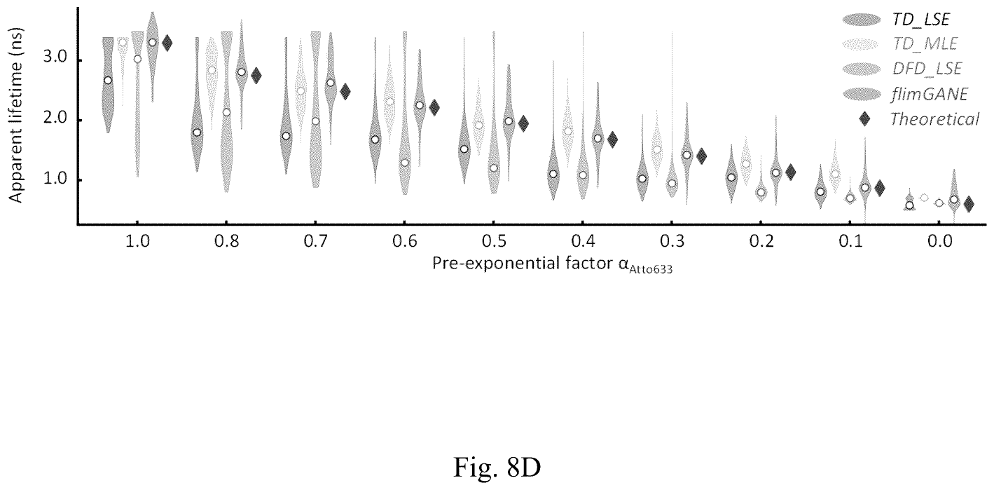

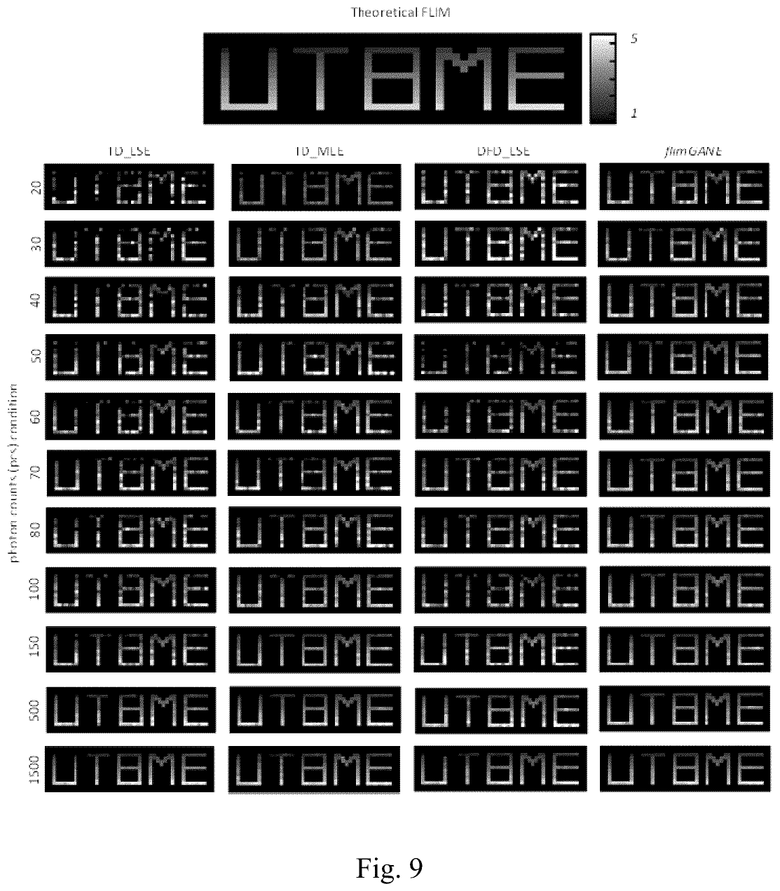

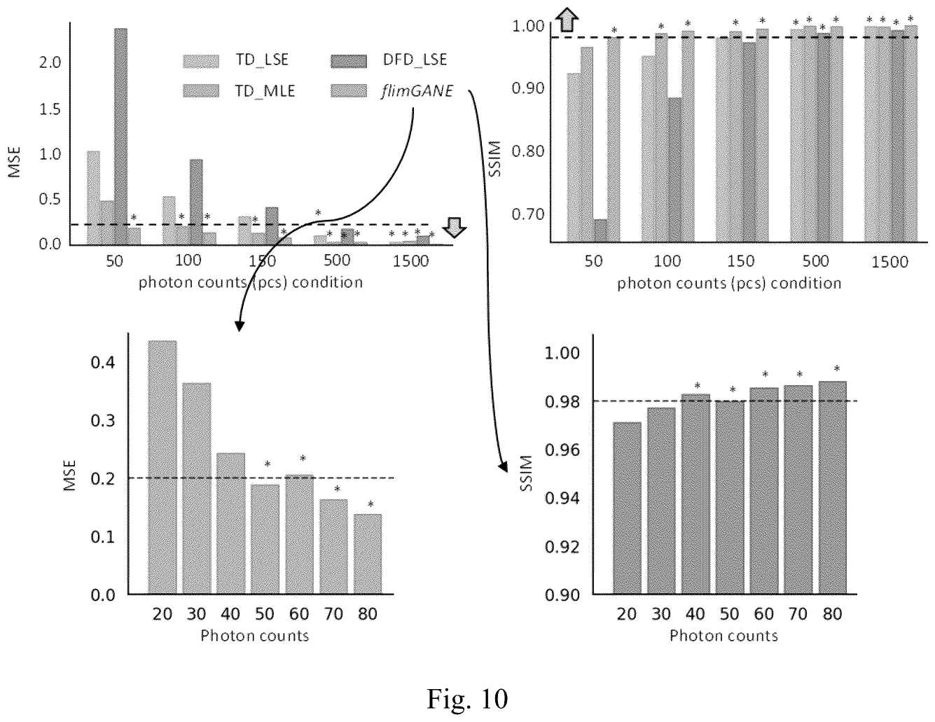

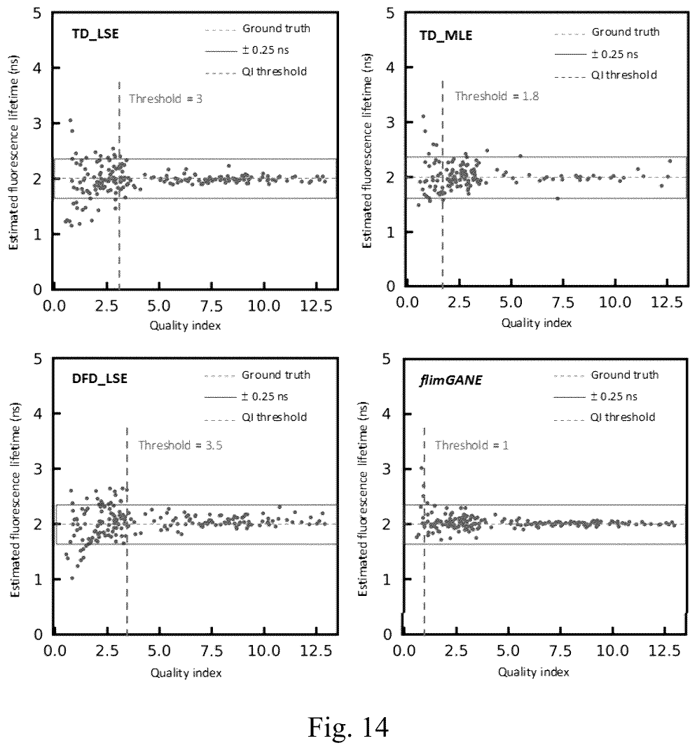

The network was trained using a MC simulation dataset (FIG. 5). A Python program was employed to simulate the photon collection process in the counting device with 256 time bins, following the probability mass function (pmf) numerically calculated by the convolution of an experimentally obtained instrument response function and a theoretical two-component decay model (α₁, τ₁, 1−α₁, and τ₂) at a selected emission rate (rate). Depending on the fluorophores that users want to image, proper α₁, τ₁, τ₂ and rate parameters that span the range of interest could be selected (Table 2, below), generating about 600 normalized ground truths and 300 k degraded decays for training G and D. The adversarial network training was completed in 6.9 hours (see FIG. 1F). After training, upon input of a normalized experimental fluorescence decay, G output a “normalized ground-truth mimicking” histogram, termed a Gₒᵤₜₚᵤₜ (FIG. 1B; FIG. 3A), which was indistinguishable from a ground truth by D within 0.17 ms. E, which was separately trained on the ground truths and completed in 5 hours, was then employed to extract the key lifetime parameters (α₁, τ₁, and τ₂) from the Gₒᵤₜₚᵤₜ within 0.15 ms. To demonstrate the reliability of the disclosed flimGANE method, a set of 14×47 “UTBME” FLIM images was created in silico (independently generated, not used in the training process) at three photon emission rates (50, 100 and 1,500 photons per pixel). At 1,500 photons per pixel, all four methods generated high-fidelity FLIM images (based on the apparent lifetime, τ_{α}=α₁τ₁+(1−α₁)τ₂), with mean-squared errors (MSE) less than 0.10 ns². At 100 photons per pixel, the disclosed flimGANE method had similar performance as the TD_MLE method (MSE were both less than 0.20 ns²), but it clearly outperformed the TD_LSE, TD_MLE, and DFD_LSE methods at 50 photons per pixel (0.19 vs. 1.04, 0.49 and 2.41 ns², respectively. See FIG. 8A, FIG. 9, FIG. 10, FIG. 14, Tables 3, and Table 4). Speed analysis showed that flimGANE was 258 and 2,800 times faster than the TD_LSE and TD_MLE methods, respectively (flimGANE—0.32 ms per pixel, TD_LSE—82.40 ms, TD_MLE—906.37 ms). While DFD_LSE offered a relatively high speed in generating FLIM images (3.94 ms per pixel), its accuracy and precision were both worse than those of flimGANE. In contrast, being a computationally intensive method, TD_MLE offered the accuracy and the precision, but not the speed. Only flimGANE provided all of speed, accuracy and precision in generating FLIM images. In addition, the MLE method became unreliable in the extremely low-photon-count condition (50 photons per pixel), while flimGANE still provided a reasonable result.

TABLE 2

| | Two | | | | | | |
|---|---|---|---|---|---|---|---|
| | dyes | | | | | | |
| | mixing | | | | | Auto- | Auto- |
| | in | Barcode | | HeLa cell, | | fluorescence - | fluorescence - |
| Parameters | solution | beads | Convallaria | YFP | CFP | FAD | NADH |
| α₁ | 0.0~1.0 | 0.0~1.0 | 0.98~1.00 | 0.98~1.00 | 0.0~1.0 | 0.0~1.0 | 0.0~1.0 |
| τ₁ (ns) | 0.5~0.7 | 1.8~2.0 | 0.05~10.0 | 0.5~5.0 | 1.1 | 0.3 | 0.4 |
| τ₂ (ns) | 3.2~3.4 | 3.4~3.6 | N/A | N/A | 3.6 | 3.0 | 2.4~4.0 |
| IRF with excitation laser | diode | diode | white laser | diode | diode | diode laser | diode laser |
| | laser | laser | | laser | laser | | |
| rate | 50, 100, 500, 1,500, 5,000 photons per pixel | | | | | | |
| No. of degraded decays | 990k | 990k | 300k | 69k | 55k | 55k | 467.5k |
| No. of ground truths | 99 | 99 | 600 | 138 | 11 | 11 | 187 |
| Training time for G and D (hrs) | 18 | 18 | 6.1 | 1.5 | 1.4 | 1.4 | 6.2 |
| Training time for E (hrs) | 0.1 | 0.1 | 0.1 | 0.1 | 0.1 | 0.1 | 0.1 |
| Training time for combing G and E (hrs) | 0.8 | 0.8 | 0.7 | 0.6 | 0.1 | 0.1 | 0.7 |
| Total model training time (hrs) | 18.9 | 18.9 | 6.9 | 2.2 | 1.6 | 1.6 | 7.0 |

The microscope's instrument response function (IRF) depending mainly on the width of the laser pulse and on the timing dispersion of the detector affects the accuracy of measured fluorescence lifetime. To accurately reconstruct FLIM images, the IRF should be taken into consideration during lifetime estimation. However, a shift between the IRF and the acquired photon histogram was often observed when tagging a photon with arrival time or phase, possibly due to the instability of the data acquisition electronics caused by radio-frequency interference, laser lock instability, and temperature fluctuation. As this shift often varied and would complicate the flimGANE analysis, a preprocessing step, termed Center of Mass Evaluation (CoME), was introduced to adjust (or standardize) the temporal locations of the experimental decays. Using the temporal location of a fixed IRF as a reference, CoME shifted the decay histogram back to the proper position (see FIG. 2A, FIG. 2B, FIG. 2C, and FIG. 8B). After preprocessing, the apparent lifetimes estimated by flimGANE were free of bias.

With reference to FIG. 2A, in order to calibrate the temporal shift between the IRF and the fluorescence decay histogram, a calibration line was generated to adjust the shift difference between them. First, MC simulations were performed to generate 1,000 simulated decay histograms for each lifetime value (1.0˜4.5 ns) at different conditions (150, 500, 1500, 5000 photon counts). Second, CoM analysis was performed to obtain the mass center of each decay histogram and IRF. All the analysis results were plotted with the x axis as lifetime value and y axis as the distance of mass centers between fluorescence decay histogram and IRF (error bars, standard deviation, n=1000). A linear regression line, calibration line, was calculated by fitting the analysis results.

With reference to FIG. 2B, the calibration line for center of mass evaluation (CoME) was consistent over different photon counts. The analysis results in FIG. 2A were plotted with distinct photon count conditions (error bars, standard deviation, n=250). It was demonstrated that the calibration is independent of the photon counts. The mean of the difference of CoM between IRF and decay histograms was the same at varying conditions. Moreover, it is expected to observe a higher variance at the low-photon-count condition.

With reference to FIG. 2C, A real-world application of the CoME is shown. The experimental fluorescence decay histogram aligned well with IRF based on CoME. Given the fluorescent dye with known lifetime (theoretical fluorescence lifetime of Atto633=3.3 ns), the desired difference of mass centers (unit: bins) of Atto633 was calculated. CoME analysis was then performed on the experimental IRF and fluorescence decay histogram to obtain the raw difference of CoM. Based on the calibration line, comparing the raw difference with the desired difference of CoM, the temporal shift was determined with the calibration line, and the experimental fluorescence decay histogram was shifted back to the desired location.

CoME improved the lifetime estimate from 1.34 to 2.11 ns with a decay curve with the theoretical value of 2.21 ns. FIG. 8C and FIG. 8D depict summarized representative results for deep-learning-based lifetime analysis of mixtures of fluorescent dyes. Lifetime estimates from the herein-described model (0.68, 0.88, 1.13, 1.42, 1.70, 1.99, 2.26, 2.64, 2.82, 3.31 ns) matched very well with the theoretical values (0.60, 0.87, 1.14, 1.41, 1.68, 1.95, 2.22, 2.49, 2.76, 3.30 ns) as compared with DFD_LSE (0.62, 0.70, 0.80, 0.95, 1.09, 1.21, 1.29, 1.99, 2.14, 3.04 ns). These results illustrate that the deep network successfully inferred the lifetimes of two components from bi-exponential decay signals.

As the MC simulation consisted of the probability mass function (pmf), fluorescence decay profile, and pre-defined number of samples sampled based on given pmf, it not only mimicked the photon emission process but also allowed for direct specification of the number of photons in the decay curves (FIG. 5) Referring to FIG. 5, schematics of simulation data generation with the Monte Carlo method are shown. First, the instrument response function (IRF) was obtained from the experiments. Given the pre-defined lifetime parameters, a bi-exponential decay model was then obtained. After convolution with the experimental IRF, the convoluted decay histogram was normalized to have unit area under curve. Regarding the normalized function as pmf, which served as the ground-truth decay histogram, MC simulation was implemented based on the given pmf to generate samples with the size as the assigned photon counts. The simulated decay histogram was then obtained from the resulting samples plotted as histogram.

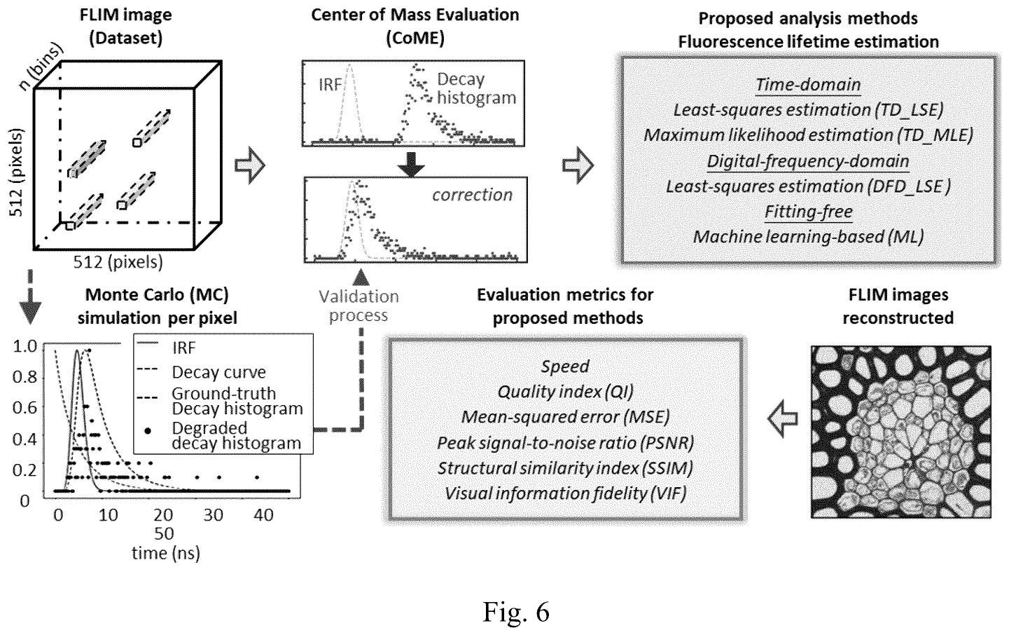

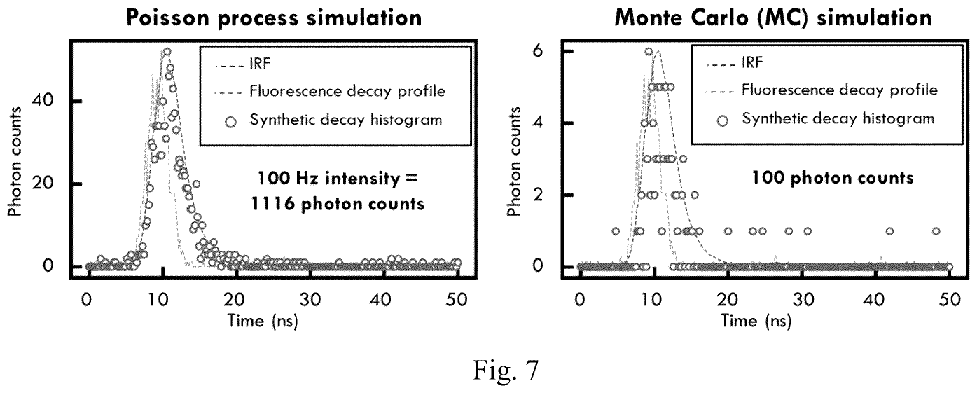

Further detail is shown in FIG. 6. FIG. 7 illustrates the difference between the Monte Carlo method and a Poisson process method as discussed above.

Simulation data was generated in silico with a Monte Carlo method for each training sample. First, multiple sets of ground truth were determined based on the lifetimes (τ₁ and τ₂) and the fraction amplitude (α₁). For each ground truth, different photon counts (pcs) and number of duplicates (e.g., 100) were assigned to construct the training dataset. For every training sample, it was assigned a value of short lifetime (τ₁) long lifetime (τ₂), fraction amplitude of short lifetime species (α₁), and photon counts (pcs). The IRF was obtained by averaging across all the pixels of the calibration image taken at the beginning of the experiment. These parameters were employed to generate the probability mass function that describes the distribution of the photon arrival time via Equations 12 and 13.

$$\begin{matrix}P ( t ) = N ( IRF ( t ) ⊗ [ {α}_{1} {e}^{- \frac{t}{{τ}_{1}}} + ( 1 - {α}_{1} ) {e}^{- \frac{t}{{τ}_{2}}} ] ) & Equation 13 \\ N ( f ( t ) ) = \frac{f ( t )}{sum ( f ( t ) )} & Equation 14\end{matrix}$$

Given the probability mass function, the Monte Carlo simulation method was performed to extract a specified number (photon counts, pcs) of samples. Those extracted samples were then used to generate the simulated (degraded) decay histogram.

With reference to FIG. 1A, in discriminator 102 (WGAN-D), a multilayer perceptron was used to map the incoming decay histogram into a space that identified whether the input was real or fake. 103 is a schematic structure of estimator models. A multi-task layer was employed to estimate the corresponding fluorescence lifetime parameters, fraction of long lifetime species, lifetime of longer lifetime species, and lifetime of shorter lifetime species. 104 shows a schematic structure of a disclosed model. The model combines the pre-trained WGAN-G (101) and Estimator (103) together to form a novel fluorescence lifetime analysis. The estimator 103 calculates accurate lifetime parameters from a high-QI fluorescence decay histogram, reconstructed from a lower-QI fluorescence decay histogram by the generator 101.

After training the generator 101, the discriminator 102, and the estimator 103, the disclosed system was capable of transforming an acquired low-count decay curve into a higher-count one using matched pairs of acquired low-count and synthetic decay curves, as shown in FIG. 3A. With reference to FIG. 3A, given the flimGANE framework, the normalized low-photon-count decay histogram was transformed into a normalized ground-truth mimicking histogram. At the beginning of the training stage, the output from the generator was chaotic. The generator-inferred fluorescence decay histogram gradually matched with the ground truth during the process of training.

With reference to FIG. 9, a fluorescence decay histogram image was generated through MC simulation with different conditions (lifetime, τ=1.0˜5.0 ns; photon counts, pcs=20, 30, 50, 60, 70, 80, 100, 150, 500, 1500). It was obvious that flimGANE outperformed other analysis methods. As expected, under extremely low-photo-count condition (=50 counts), TD_MLE, TD_LSE, and DFD_LSE were unable to make an accurate estimation. Under low-photon-count conditions (100, 150 counts), TD_MLE was close to the accurate estimation; however, TD_LSE and DFD_LSE were only able to generate accurate FLIM images with high-photon-count conditions (>500 counts).

Under extremely low-light-level condition (p.c.=80), flimGANE outperformed other methods with the least mean squared error (MSE=0.14<0.71 for TD_LSE, 0.46 for TD_MLE, and 0.60 for DFD_LSE; see FIG. 10 and Table 3. At low photon counts (p.c.=150), flimGANE and TD_MLE results were in good agreement with the theoretical results as evidenced by very low mean squared error (MSE) as 0.20 for both methods. (see FIG. 8A, FIG. 10, and Table 3).

With reference to FIG. 10, the reconstructed “UT BME” FLIM images obtained by different analysis methods were evaluated by mean squared error (MSE, threshold=0.2) and structural similarity index (SSIM, threshold=0.98). The performance of different analysis methods was evaluated under five conditions, 50, 100, 150, 500, 1500 photon counts. Under extremely low-photon-count condition (50 counts), the MSE and SSIM between the reconstructed FLIM images from flimGANE and the ground-truth FLIM images were less than and larger than 0.98. TD_MLE provided MSE less than 0.2 and SSIM larger than 0.98 when the photon counts were greater than 100. TD_LSE and DFD_LSE could provide MSE less than as the photon counts were greater than 500. The performance boundary of flimGANE was further investigated. flimGANE could still provide MSE less than 0.2 and SSIM greater than 0.98 as the photon counts increased beyond 50.

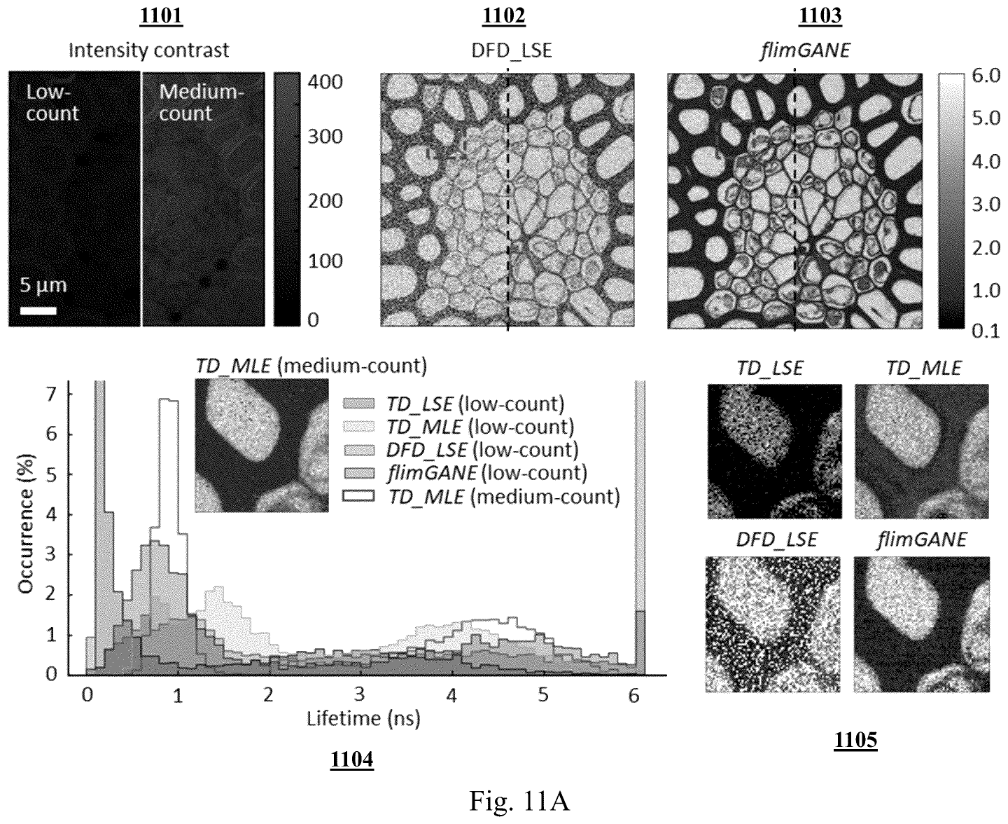

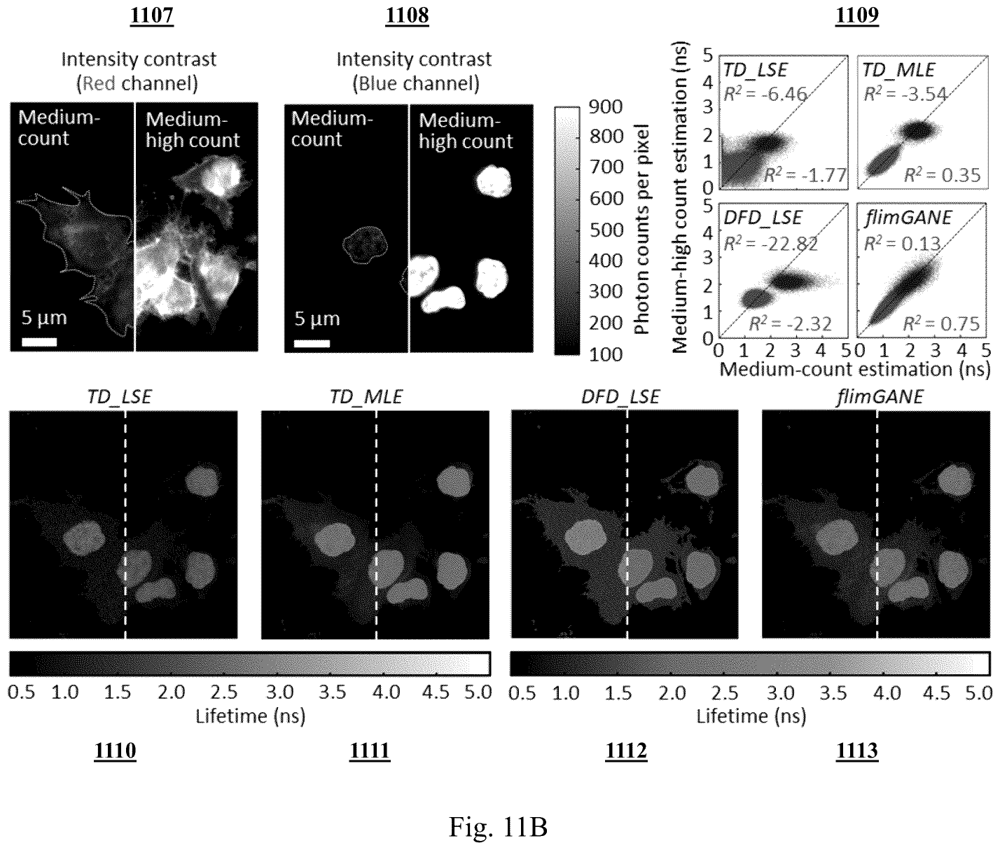

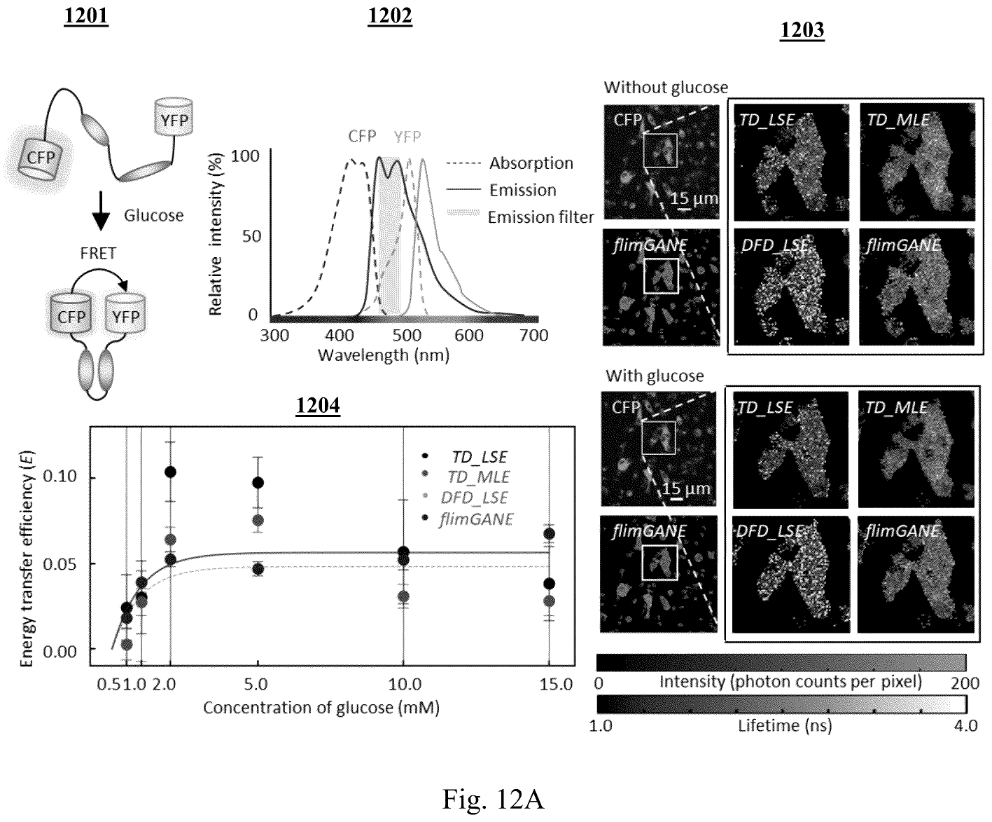

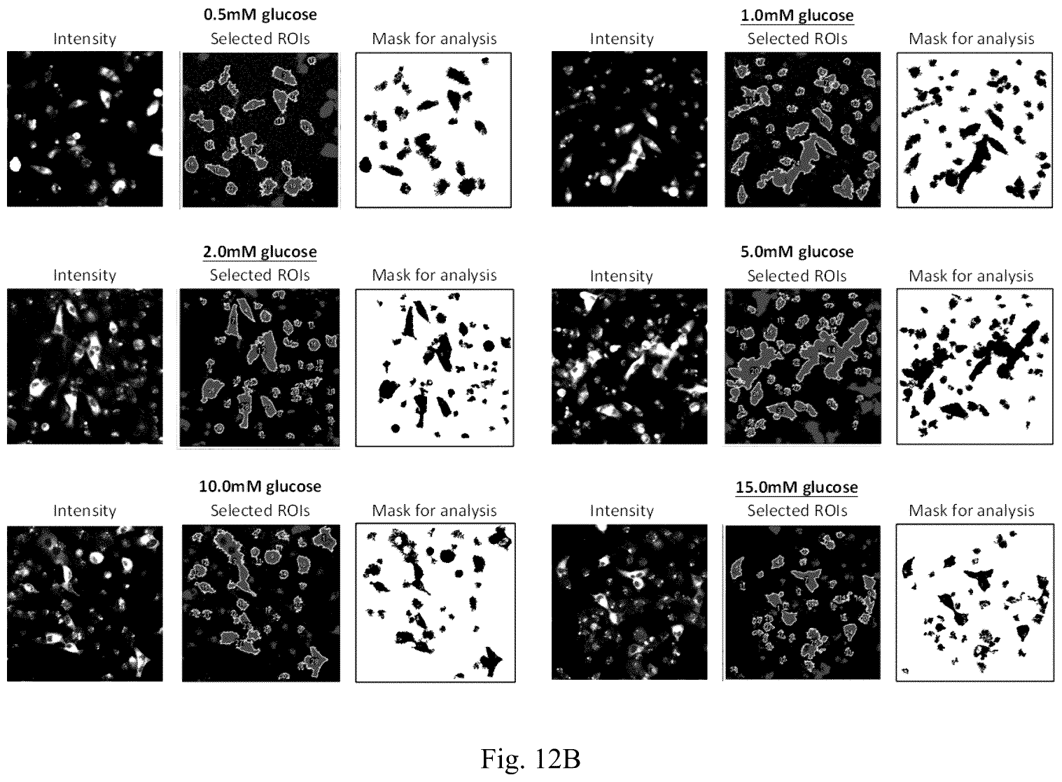

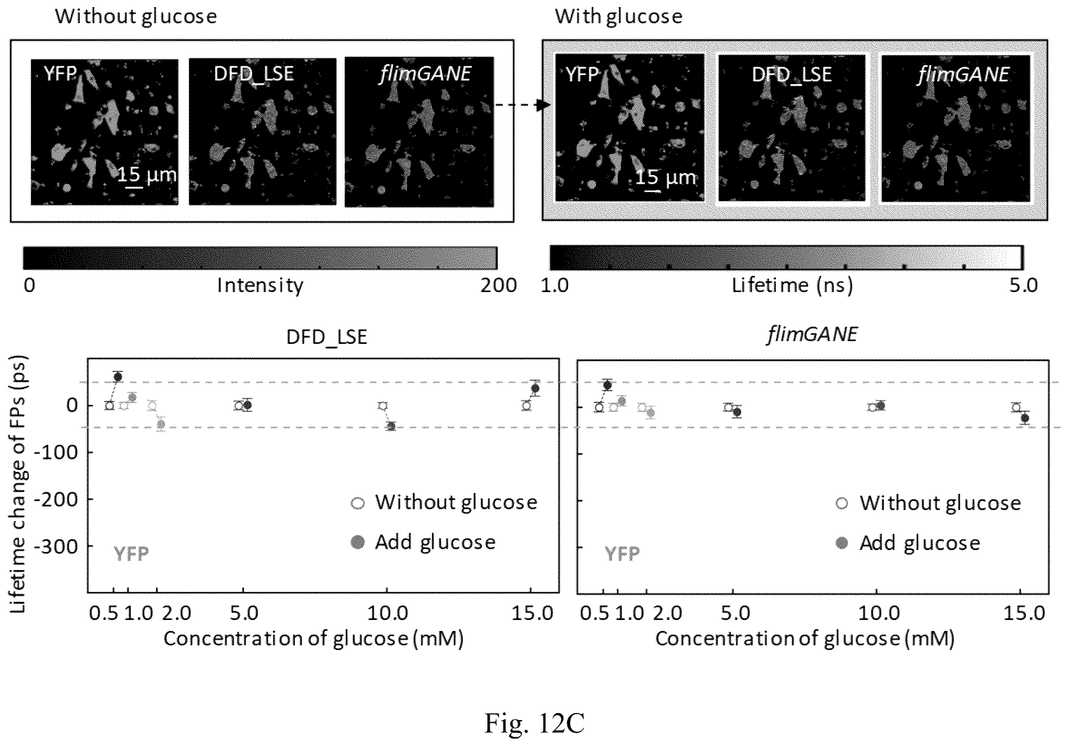

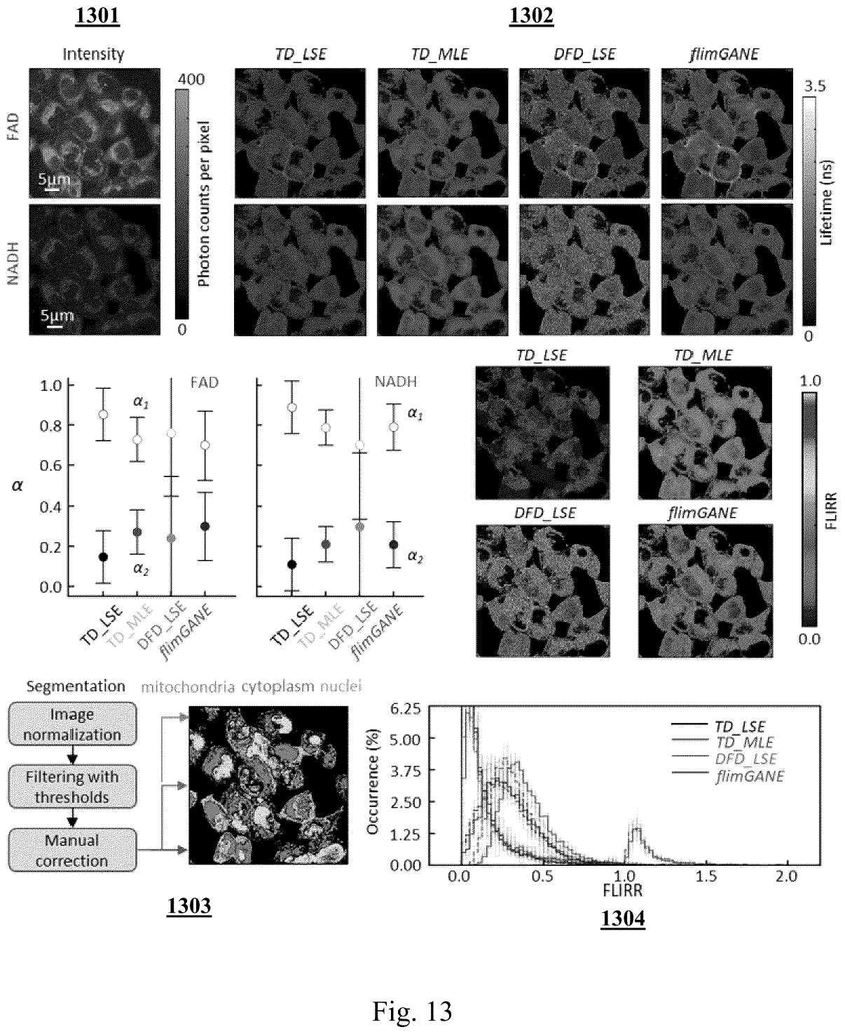

When the number of time-tagged photon counts acquired for the fluorescence decays increased 10-fold, all the lifetime analysis approaches predicted accurately with MSE<0.2. Accordingly, TD_MLE-based FLIM is regarded as the ground-truth FLIM for live HeLa cell imaging (see FIG. 11A and FIG. 11B), FRET imaging (see FIG. 12A, FIG. 12B, and FIG. 12C), and autofluorescence imaging (see FIG. 13) with more than 150 photon counts. However, flimGANE was 258 and 2800 times faster than TD_LSE and TD_MLE (flimGANE=0.32 ms per pixel; TD_LSE=82.40 ms per pixel; TD_MLE=906.37 ms per pixel), respectively (see Table 4 below)

TABLE 3

| Condition | | | | |
|---|---|---|---|---|
| (photons | | | | |
| per pixel) | TD_LSE | TD_MLE | DFD_LSE | flimGANE |
| 20 | 2.32 | 1.60 | 1.26 | 0.44 |
| 30 | 1.44 | 0.69 | 1.41 | 0.36 |
| 40 | 1.17 | 0.44 | 0.85 | 0.24 |
| 50 | 1.04 | 0.49 | 2.41 | 0.19 |
| 60 | 0.83 | 0.56 | 1.11 | 0.20 |
| 70 | 0.57 | 0.66 | 0.44 | 0.16 |
| 80 | 0.71 | 0.46 | 0.60 | 0.14 |
| 100 | 0.54 | 0.20 | 0.95 | 0.14 |
| 150 | 0.32 | 0.07 | 0.51 | 0.08 |
| 500 | 0.11 | 0.03 | 0.15 | 0.04 |
| 1500 | 0.04 | 0.05 | 0.06 | 0.01 |

TABLE 4

| Condition | | | | |
|---|---|---|---|---|
| (photons | | | | |
| per pixel) | TD_LSE | TD_MLE | DFD_LSE | flimGANE |
| 20 | 0.83 | 0.88 | 0.92 | 0.97 |
| 30 | 0.88 | 0.96 | 0.90 | 0.98 |
| 40 | 0.88 | 0.96 | 0.94 | 0.98 |
| 50 | 0.92 | 0.96 | 0.69 | 0.98 |
| 60 | 0.94 | 0.98 | 0.91 | 0.99 |
| 70 | 0.95 | 0.97 | 0.97 | 0.99 |
| 80 | 0.93 | 0.98 | 0.95 | 0.99 |
| 100 | 0.94 | 0.99 | 0.90 | 0.99 |
| 150 | 0.98 | 0.99 | 0.96 | 0.99 |
| 500 | 0.99 | 1.00 | 0.99 | 1.00 |
| 1500 | 1.00 | 1.00 | 0.99 | 1.00 |

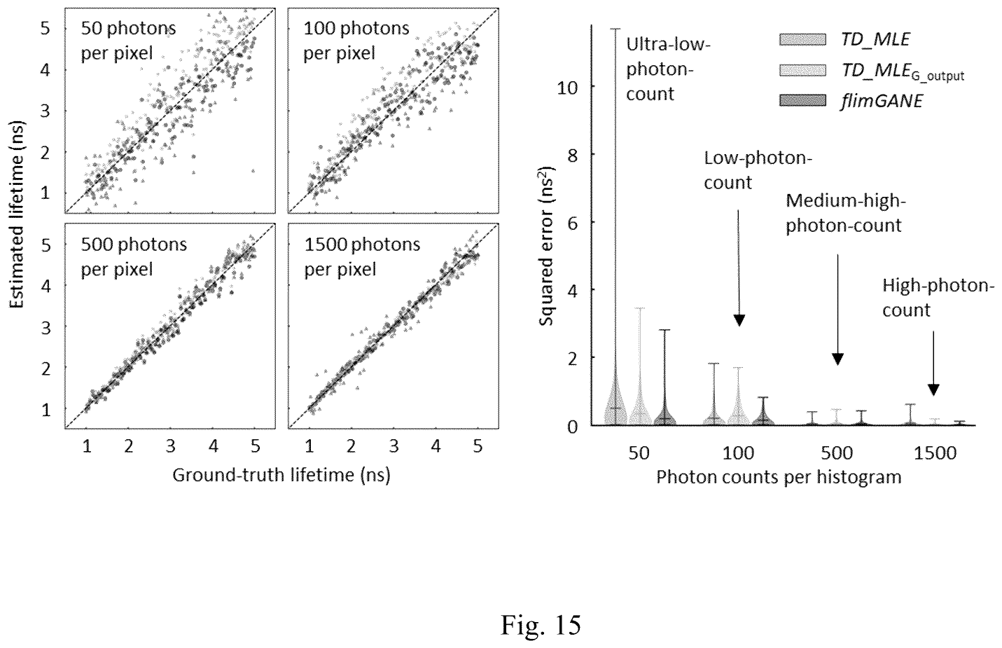

To demonstrate how the flimGANE algorithm outperforms the traditional TD_MLE method, a comparison was performed between the MLE determination for low photon count raw data (TD_MLE) and high-photon count data generated from the low photon count data are (TD_MLE_{G_output}) (see FIG. 15). Running TD_MLE on the generator outputs (TD_MLE_{G_output}) produced results better than that from TD_MLE under ultra-low-photon-count condition.

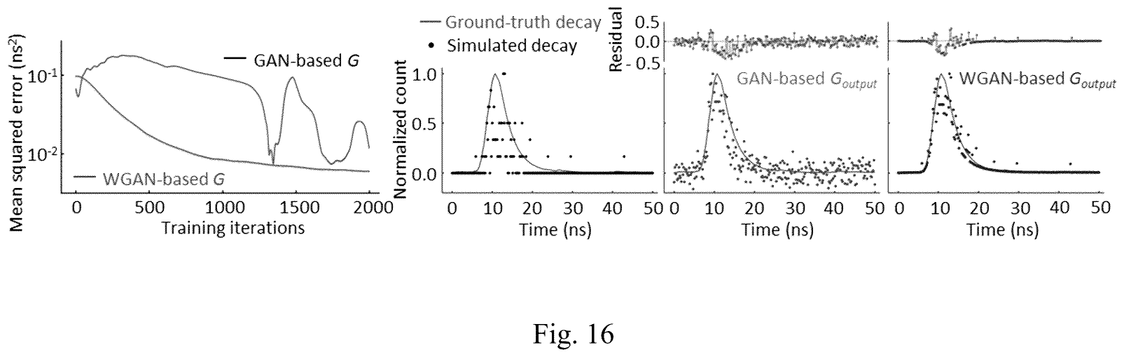

With reference to FIG. 16, the set of graphs demonstrate that WGAN algorithms implemented in flimGANE successfully learned to reconstruct the ground-truth “mimicking” fluorescence decay histograms, which could not be achieved by a classical GAN algorithm.

To prove the reliability of flimGANE in estimating an apparent fluorescence lifetime from a mixture, two fluorophores, Cy5-NHS ester (τ₁=0.60 ns) and Atto633 (τ₂=3.30 ns), were mixed at different ratios, creating ten distinct apparent fluorescence lifetimes (r a) between 0.60 and 3.30 ns. Here τ₁ and τ₂ were measured from the pure dye solutions and estimated by TD_MLE, whereas the theoretical apparent lifetime τ_{ατ} was predicted by the equation τ₁α₁+τ₂(1−α₁). α₁, the pre-exponential factor, was derived from the relative brightness of the two dyes and their molar ratio. Based on 256×256-pixel images and photon emission rates fluctuating between 80-200 photons per pixel, flimGANE and TD_MLE produced the most accurate and precise τ_{α} estimates among the 4 methods (see FIG. 8D and Table 5, below). TD_LSE and DFD_LSE performed poorly in this low-light, two-dye mixture experiment.

TABLE 5

| Ratio | | Theoretical | | | | |
|---|---|---|---|---|---|---|
| (Cy5:Atto | Photons per | apparent lifetime, | TD_LSE | TD_MLE | DFD_LSE | flimGANE |
| 633) | pixel | τ_{α} (ns) | (ns) | (ns) | (ns) | (ns) |
| 10:0 | 178 | 0.60 | 0.59 ± 0.05 | 0.71 ± 0.03 | 0.62 ± 0.02 | 0.68 ± 0.15 |
| 9:1 | 135 | 0.87 | 0.81 ± 0.14 | 1.11 ± 0.17 | 0.70 ± 0.06 | 0.88 ± 0.10 |
| 8:2 | 127 | 1.14 | 1.05 ± 0.19 | 1.28 ± 0.20 | 0.80 ± 0.09 | 1.13 ± 0.11 |
| 7:3 | 121 | 1.41 | 1.02 ± 0.19 | 1.52 ± 0.23 | 0.95 ± 0.13 | 1.42 ± 0.14 |
| 6:4 | 127 | 1.68 | 1.10 ± 0.22 | 1.82 ± 0.27 | 1.09 ± 0.21 | 1.70 ± 0.17 |
| 5:5 | 120 | 1.95 | 1.53 ± 0.26 | 1.92 ± 0.26 | 1.21 ± 0.28 | 1.99 ± 0.25 |
| 4:6 | 129 | 2.22 | 1.68 ± 0.27 | 2.32 ± 0.33 | 1.29 ± 0.29 | 2.26 ± 0.25 |
| 3:7 | 134 | 2.49 | 1.74 ± 0.28 | 2.49 ± 0.34 | 1.99 ± 1.20 | 2.64 ± 0.37 |
| 2:8 | 137 | 2.76 | 1.80 ± 0.33 | 2.85 ± 0.37 | 2.14 ± 1.27 | 2.82 ± 0.20 |
| 0:10 | 190 | 3.30 | 2.67 ± 0.60 | 3.32 ± 0.06 | 3.04 ± 1.05 | 3.31 ± 0.30 |

With reference to Table 5, the ± in the timing columns are one standard deviation from the mean by Gaussian distribution fitting.

### Oligonucleotide-Coated Beads (ON-Bead) by Lifetime Discrimination

The oligonucleotide-coated microbeads preparation was carried out using the following protocol: 2 μL (10 mg/mL) streptavidin-coated microbeads were transferred into a 1.5 mL centrifuge tube. The microbeads were washed with 20 μL 1×PBS twice by centrifuging at 10K rpm for 3 min and resuspended in 1×PBS. The different ratios of mixed biotinylated single-strand DNA probes (Probe1: 5′Atto633-TGGTCGTGGGGCAACTGGGTT-biotin (3.5 ns) and Probe2: 5′Cy5-TTTTTTTTTTTT-biotin (1.9 ns) were added and incubated for 15 min at room temperature with gentle mixing. The coated microbeads were than separated by centrifuging at rpm for 3 min. The unbound biotinylated probes were removed by washing three times in 1×PBS. Then, two species coated beads were ready for downstream applications. Here, three different barcode beads were demonstrated, (see Table 5) imaged by the FLIM. The FLIM images for fluorescence lifetime barcode beads were taken by the laser light focused through a 60× NA=1.2, water immersion objective. A diode laser was used as an excitation source at 635 nm. The fluorescence was detected with an avalanche photodiode after passing through a bandpass filter. FLIM images (512×512 pixels) were scanned three times with dwell time 0.04 ms/pixel. Cy5 in water (1 ns) was used for calibrating FLIM system.

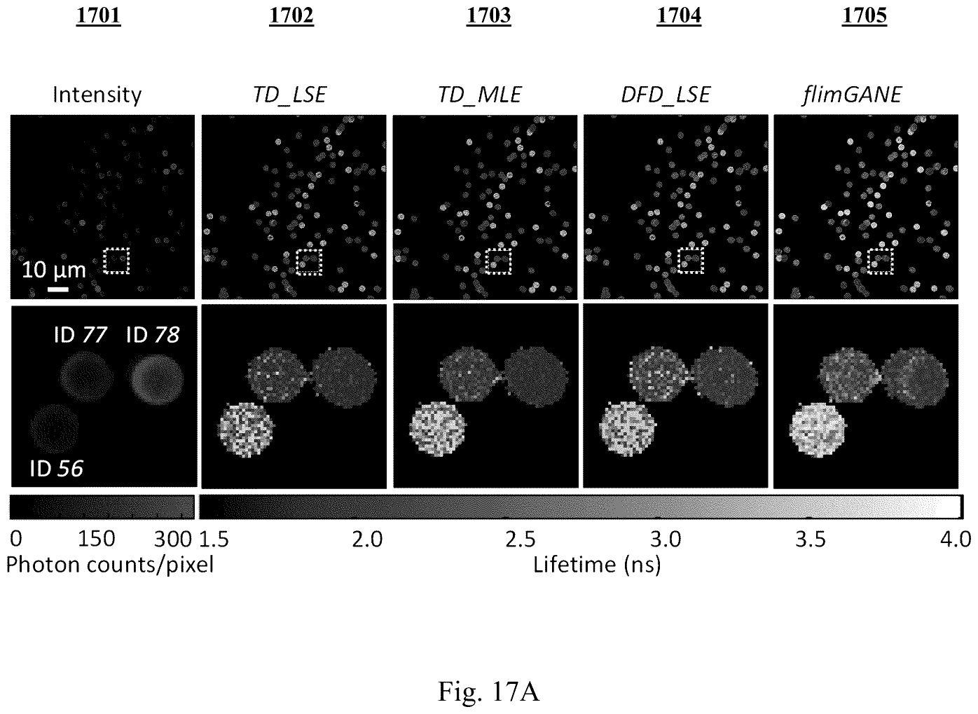

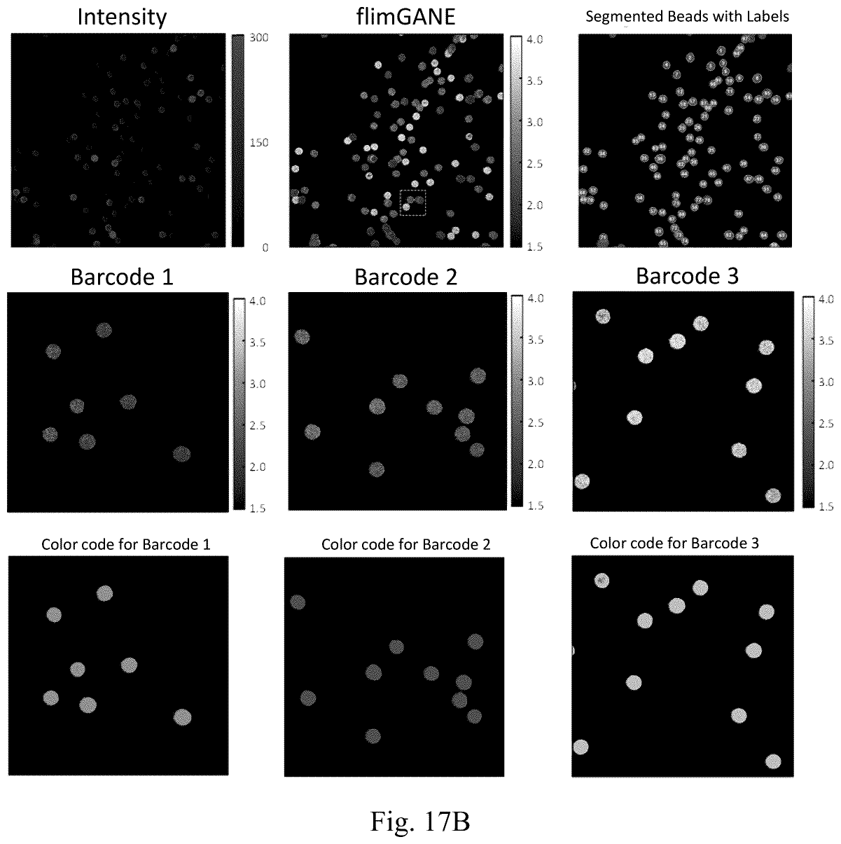

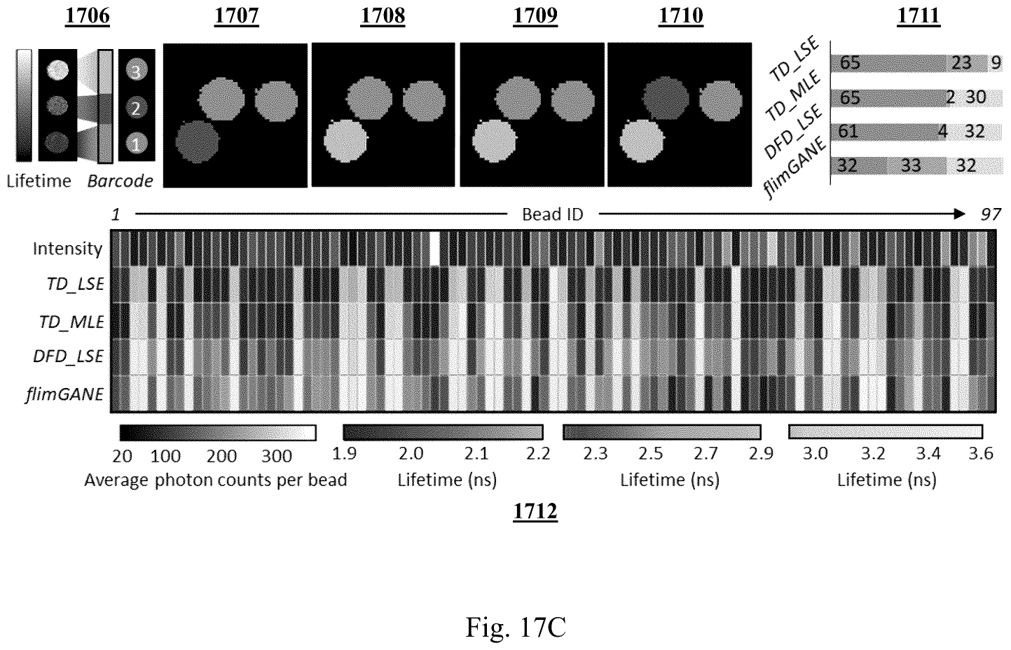

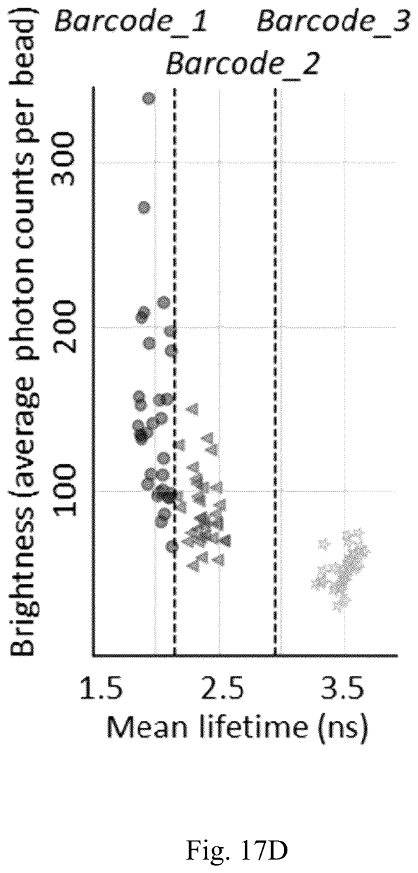

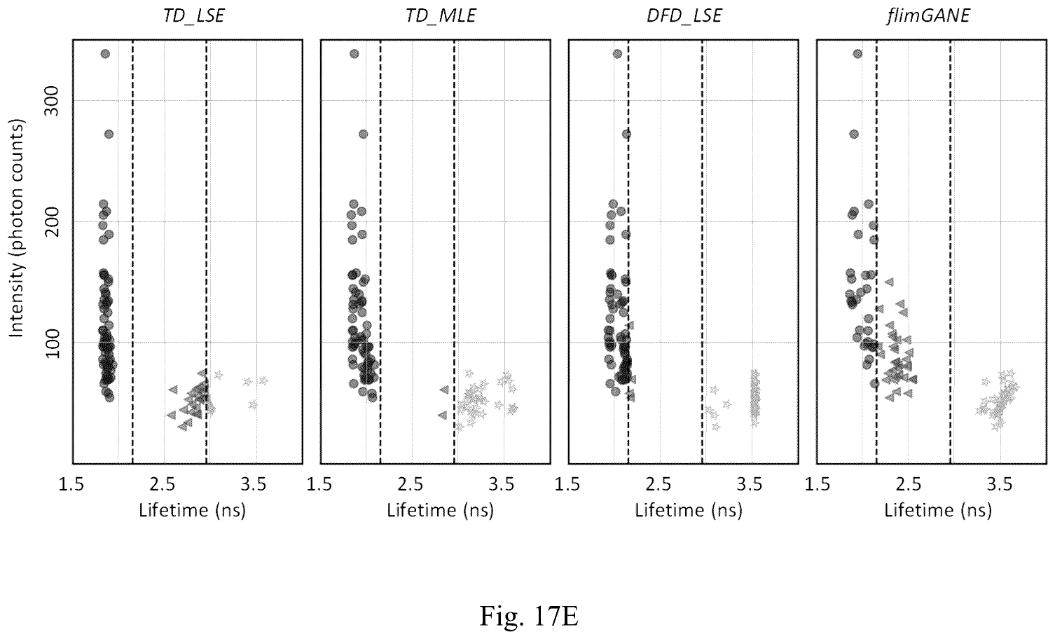

To create fluorescence lifetime barcodes, biotinylated Cy5- and Atto633-labeled DNA probes were mixed at three different ratios, Cy5-DNA:Atto633-DNA=1:0 (1.9 ns, barcode_1); 1:1 (2.4 ns, barcode_2) and 0:1 (3.5 ns, barcode 3), and then conjugated to streptavidin-coated polystyrene beads 3-4 μm in size, using the process described above. See also Table 6 below. The cover slip with the three barcode beads was scanned by a confocal microscopic system with a 20 MHz 635 nm diode laser and a fastFLIM module for 31 seconds, generating 512×512-pixel DFD data with photon counts ranging from 50-300 per pixel (Images 1701 in FIG. 17A). The acquired DFD data (i.e., cross-correlation phase histograms) were further converted into time decays for flimGANE, TD_LSE and TD_MLE analysis (Images 1702 and 1703 in FIG. 17A). Each lifetime bead from the FLIM barcode image was identified by ImageJ ROI manager and assigned an ID number (see FIG. 17B). Lifetime values from every bead (˜292 pixels) were plotted as a histogram and then the mean of the lifetime was extracted by Gaussian fitting. Pseudocolor was used to map the mean lifetime for each bead. Bule, red and yellow represented barcode 1, barcode 2 and barcode 3, respectively (See FIG. 17C). It was clear that flimGANE was the only method that can correctly identify the three barcodes and restore the 1:1:1 barcode ratio, while other methods often misidentified the barcodes (See 1707-1710 in FIG. 17C).

TABLE 6

| | | Theoretical |
|---|---|---|
| | | apparent |
| | Ratio | lifetime |
| Barcode | (Probe1:Probe2) | (ns) |
| 1 | 0:10 | 1.90 |
| 2 | 5:5 | 2.40 |
| 3 | 10:0 | 3.50 |

Next, all mean lifetime values obtained by the different methods were plotted into two-dimensional (photon counts versus lifetime) scatter plots showing that the lifetime populations were independent of the intensities of individual beads (see FIG. 17D and FIG. 17E). Interestingly, although the photon counts of beads for the barcode_1 group varied across a six-fold difference, the coefficient of variance (CV) of the lifetime was as low as 0.06. When classifying 97 beads into three barcodes, the populations of flimGANE were found to be similar to the 1:1:1 mixing ratio, resembling the barcode distribution of the experimental condition (see graph 1711 in FIG. 17C). The details of each bead were investigated, illustrating that intensity failed to perform a reliable three-group classification (see graph 1712).

### Visualizing Cellular Structures of Convallaria and HeLa Cells

The Convallaria (lily of the valley) cover slide was stained on 26 mm×76 mm glass slides. A supercontinuum white laser was used as an excitation source at 630/38 nm. The fluorescence was detected with an avalanche photodiode after passing through a bandpass filter. The FLIM images were taken by the laser light focused through a 60×NA=1.2, water immersion objective. FLIM images (512×512 pixels) were scanned one time (for low-photon-count condition) and three times (for medium-photon-count condition) with dwell time 0.1 ms/pixel. Cy5 in water (1 ns) was used for calibrating FLIM system.

Live HeLa cells were seeded onto optical imaging 8-well Lab-Tek chambered cover glass with cell density 70-90% confluent per well and grown overnight at 37° C. in a humidified atmosphere with 5% CO2 prior to staining. Cells were maintained in DMEM/F12 medium supplemented with 10% heat-inactivated fetal bovine and 50 U/mL penicillin-streptomycin. CellMask™ Green or CellMask™ Red plasma membrane stain (1 μg/mL) were used to stain the plasma membrane of live cells for 10 min at 37° C. The staining solution was removed from the chambered cover glass. Then, the live cells were washed with PBS three times. The nucleus was stained by the permeable Hoechst 33342 dye for 10 min at 37° C. and washed with PBS three times. Cells were then kept in the phenol red-free DMEM/F12 for the FLIM images acquisition. A diode laser was used as an excitation source at 405, 488 and 640 nm. The FLIM images were taken by the laser light focused through a 60×NA=1.2, water immersion objective. The fluorescence was detected with an avalanche photodiode after passing through a bandpass filter. FLIM images (512×512 pixels) were taken with dwell time 0.1 and 0.2 ms/pixel, respectively. Alexa 405 in water (3.6 ns), rhodamine 110 in water (4 ns) and Cy5 in water (1 ns) was used for calibrating FLIM system.

The DFD data of Convallaria (Lily of the valley) and membrane of live HeLa cells, acquired under the low and the medium excitation power (see image 1101, FIG. 11A), were analyzed by DFD_LSE and flimGANE methods, where TD_MLE (medium-photon-count condition, ˜243 photons per pixel) served as the standard for comparison. According to the result generated by TD_MLE, two populations of fluorescence lifetime of the Convallaria sample lie at 0.90±0.13 ns; 4.84±1.20 ns, respectively. To avoid the bias introduced by the training boundary of flimGANE, the lifetime range of the training data was set to be 0.1-10 ns. A large number of failed pixels were seen in the DFD_LSE images (37% and 25% for the low and medium excitation power, respectively; white pixels in image 1102), as DFD_LSE often falsely assigned lifetimes longer than 6 ns at these pixels. The values for these failed pixels were capped at 6 ns. In addition, although two populations of lifetime were observed within the 0.2-5.5 ns by all analysis methods under low excitation power (˜83 photons per pixel on average), pixels in the flimGANE images (e.g. image 1103) had tighter distributions of their assigned lifetimes, which resembled the distributions found in the TD_MLE method (medium-count condition) (see graph 1104). With no apparent failed pixels, flimGANE provided better visualization and quantification of the structural details (see images 1105). The peak signal-to-noise ratio (PSNR) indicated that the Convallaria FLIM images generated by flimGANE were 100% more similar to the gold standard TD_MLE images than those generated by the DFD_LSE method (flimGANE—15.71, DFD_LSE—7.85). The structure similarity index (SSIM) indicated that the flimGANE images were 73% more similar to the gold standard TD_MLE images than those generated by DFD_LSE (flimGANE—0.88, DFD_LSE—0.51), and visual information fidelity (VIF) showed that the flimGANE images were 1.44-fold higher than those reconstructed by DFD_LSE (flimGANE−DFD_LSE—0.09; see Table 7 below, which shows an MSE, PSNR, SSIM, and VIF comparison of different analysis methods for Convallaria FLIM images (Standard: medium-count TD_MLE FLIM)).

TABLE 7

| Condition | | | | | |
|---|---|---|---|---|---|
| (photons | | | | | |
| per pixel) | Method | MSE | PSNR | SSIM | VIF |
| 50-200 photon | TD_LSE | 2.01 | 10.94 | 0.71 | 0.17 |
| counts per pixel | TD_MLE | 0.52 | 16.84 | 0.89 | 0.22 |
| | DFD_LSE | 4.10 | 7.85 | 0.51 | 0.09 |
| | flimGANE | 0.61 | 15.71 | 0.88 | 0.22 |

In the HeLa cell sample, the membrane and nucleus were stained with CellMask™ Red and Hoechst excited by 640 nm and 405 nm diode lasers, respectively. The contour of the cell membrane and nucleus were not able to be clearly identified by intensity fluorescence images under low excitation power (see images 1107, 1108 in FIG. 11B). Although FLIM overlay images allow for visualization of cellular structures at either medium-high- or medium-count conditions, insufficient photon counts at each pixel may lead to bias in lifetime estimates. Using medium-high-count FLIM images (˜600 photons per pixel) as the standard for comparison, medium-count flimGANE images (˜180 photons per pixel) clearly outperformed TD_LSE, TD_MLE and DFD_LSE in resembling the standard (R² of 0.75 in red channel, versus −1.77, 0.35, −2.32 for TD_LSE, TD_MLE and DFD_LSE, respectively; R² of 0.13 in blue channel, versus −6.46, −3.54, −22.82 for TD_LSE, TD_MLE and DFD_LSE, respectively (see graphs 1109 in FIG. 11B, and Table 8 below). When scrutinizing the assigned lifetime at each pixel, TD_LSE, TD_MLE, and DFD_LSE were found to give inconsistent lifetime estimates at two distinct excitation powers (e.g., R² in blue channel were −6.46, −3.54 and −22.82 for TD_LSE, TD_MLE and DFD_LSE, respectively) (see images 1110, 1111, 1112 in FIG. 11B), while flimGANE provided consistent lifetime estimates regardless the excitation power R² was 0.13 in blue channel (see image 1113).

TABLE 8

| Condition | | | | | |
|---|---|---|---|---|---|
| (average | | | | | |
| photons | | | | | |
| per pixel) | Method | MSE | PSNR | SSIM | VIF |
| ~180 | TD_LSE | 0.28 | 19.44 | 0.67 | 0.06 |
| (Red channel) | TD_MLE | 0.10 | 23.90 | 0.75 | 0.14 |
| | DFD_LSE | 0.24 | 20.26 | 0.68 | 0.11 |
| | flimGANE | 0.13 | 22.88 | 0.87 | 0.22 |
| ~180 | TD_LSE | 0.37 | 18.34 | 0.93 | 0.25 |
| (Blue channel) | TD_MLE | 0.12 | 23.10 | 0.95 | 0.45 |
| | DFD_LSE | 0.79 | 15.01 | 0.93 | 0.31 |
| | flimGANE | 0.10 | 24.01 | 0.98 | 0.47 |

With reference to FIG. 11A and FIG. 11B, Image 1101 of FIG. 11A shows an intensity contrast of Convallaria imaged with a size of 512×512 pixels and an intensity ranged from 50-150 counts (left; low photon counts) and from 300-400 counts (right; medium photon counts). Image 1102 is a FLIM image generated by DFD_LSE and image 1103 by flimGANE, demonstrating that flimGANE was more robust than DFD_LSE, where the estimation was independent of photon counts. Graph 1104 is a histogram of lifetime obtained from TD_LSE, TD_MLE, DFD_LSE, flimGANE, and medium-count based TD_MLE in the selected ROI showing that flimGANE showed the most similar distribution with the standard. images 1105 are a zoomed-in ROI (low-count), selected and analyzed with TD_LSE, TD_MLE, DFD_LSE and flimGANE to reveal further details of the structure.

With reference to FIG. 11B, Image 1107 shows an intensity contrast of plasma membrane of live HeLa cells imaged with a size of 512×512 pixels in red channel (685/40 nm) and an intensity ranging from 80-400 counts (left; low photon counts) and from 300-1,000 counts (right; medium photon counts). Image 1108 shows an intensity contrast of nuclei of live HeLa cells imaged with a size of 512×512 pixels in blue channel (494/34 nm) and an intensity ranging from 50-300 counts (left; low photon counts) and from 300-1,500 counts (right; medium photon counts). Graphs 1109 are 2D scatter plots of lifetime acquired at low and medium excitation power. flimGANE provided more consistent estimates at two different photon rates. Images 1110-1113 show an overlay of FLIM images in red and blue channels (left; low photon counts; right; medium photon counts).

### Quantification of Forster Resonance Energy Transfer (FRET) in Live HeLa Cells

Combined with the glucose FRET sensor, FLIM has been employed to image the glucose concentration in live cells. However, depending on the lifetime analysis methods, the trend of FRET change can be skewed, especially when the donor lifetime change is very small (e.g., only 0.1-0.3 ns). A disclosed glucose FRET sensor, termed CFP-g-YFP, consisted of a glucose binding domain flanked by a cyan fluorescent protein (CFP) donor and a yellow fluorescent protein (YFP) acceptor (see image 1201 and graph 1202 in FIG. 12A).

With reference to FIG. 12A, image 1201 and graph 1202 show normalized excitation and emission spectra of CFP and YFP. Dotted rectangles indicate transmission of emission filters and schematic of CFP-g-YFP FRET pair interaction with Glucose. Images 1203 show intensity contrast, FLIM images generated by TD_LSE, TD_MLE, DFD_LSE and flimGANE of CFP before adding 2 mM glucose, and immediately after adding 2 mM glucose. Graph 1204 shows Energy transfer efficiency, E, plotted versus the concentration of Glucose that was added (error bars, standard deviation errors on the parameter estimate, n=1507˜6824). An asymptotic phase of sigmoidal curve fitted well with the observations from flimGANE (R 2=0.92).

Triple negative breast tumor cell line, MDA-MB-231, was obtained from the American Type Culture Collection (ATCC) and grown in high-glucose (25 mM) DMEM/F12 culture medium containing 10% heat-inactivated fetal bovine serum and 50 U/mL penicillin-streptomycin. The plasmid carrying the glucose FRET sensor, pcDNA3.1 FLII12Pglu-700uDelta6. Prior to transfection, MDA-MB-231 cells were seeded in a 6-well plate and allowed with cell density 70-90% confluent per well. Transfections were performed using Lipofectamine™ LTX and Plus™ reagent according to manufacturer's instructions. Transfection medium, Opti-MEM™ I Reduced Serum Medium, contained no serum or antibiotics. Six hours post-transfection, the medium was replaced with DMEM culture medium. Three days post-transfection, medium was replaced with DMEM containing 100 μg/mL G418 for selection. After two weeks of selection, the cells were sorted by flow cytometry based on YFP expression. MDA-MB-231 cells transfected with the FRET glucose sensor were seeded onto optical imaging 8-well Lab-Tek chambered cover glass with cell density 70-90% confluent per well and grown overnight at 37° C. in a humidified atmosphere with 5% CO2. The medium was replaced with glucose-free DMEM culture medium for 24 hours before FLIM image acquisition. The FLIM images were taken by the laser light focused through a 20× objective. The fluorescence of CFP and YFP were detected by two avalanche photodiodes after passing through the bandpass filters, respectively. FLIM images (256×256 pixels) were scanned three times with dwell time 0.1 ms/pixel. Alexa 405 in water (3.6 ns) was used for calibrating FLIM system.

The overlap between CFP emission and YFP absorption leads to efficient FRET interaction (see images 1203 in FIG. 12A). The CFP-g-YFP sensor-expressed MDA-MB-231 tumor cells were starved for 24 hrs before adding different amount of glucose to the cell culture (final concentrations: 0, 0.5, 1.0, 2.0, 5.0, 10.0, 15.0 mM). The confocal scanning system collected DFD data from a 256×256-pixel area before and after the addition of glucose, which were then analyzed by TD_LSE, TD_MLE, DFD_LSE, and flimGANE methods to generate FLIM images based on the CFP donor decays. The image data was analyzed in single cell by regions of interest (ROI) selection to separate each cell from background noise (see FIG. 12B). Thousands of data points (apparent lifetimes, τ_{α}) were plotted as a histogram and the mean of lifetime was extracted by Gaussian fitting, giving one representative donor lifetime for each glucose concentration. The mean of the CFP lifetime histogram from flimGANE FLIM images shifted toward less value after the addition of glucose. However, DFD_LSE were not able to observe FRET changes in live cells due to the poor lifetime estimates of each pixel. On the other hand, YFP lifetime histogram didn't show obvious shift after the addition of glucose at different concentrations, which represented that there was no lifetime change in YFP observed, validating that variation of YFP's lifetime was not glucose specific (see FIG. 12C).

With regard to FIG. 12C, CFP-g-YFP-transfected MDA-MB-231 cells FLIM images are shown without and with 2 mM glucose for YFP channel reconstructed by flimGANE and DFD_LSE. The images of live MDA-MB-231 cells incubated in 2 mM glucose were taken with the same field of view (FOV) as the images of cells incubated in culture medium without glucose. The mean lifetime difference between the group without and with glucose was plotted versus the six concentrations of glucose (0.5, 1, 2, 5, 10, 15 nM). The variation of mean lifetime difference obtained by flimGANE before and after adding glucose was smaller (<±0.05 ns) than that obtained by DFD_LSE. The error bars represent the standard deviation errors on the parameter estimate (n=2290-6824 pixels).

The CFP FLIM images generated by four different analysis methods were directly compared at 2 mM glucose concentration. It was obviously that the flimGANE FLIM image looked more similar to the TD_MLE FLIM image than the TD_LSE and DFD_LSE FLIM images. Lifetime values from some pixels in TD_LSE and DFD_LSE FLIM images were not be correctly estimated due to a lack of photon counts (see images 1203 in FIG. 12A). The energy transfer efficiency (E) was calculated based on the equation: E=1−(τ_{DA}/τ_{D}), where τ_{D} and τ_{DA} were the representative CFP lifetimes before and after addition of glucose, respectively. Although only subtle differences were seen in the CFP donor lifetime (0.04-0.20 ns, which led to low FRET efficiencies around 0.02-0.07), flimGANE-derived FRET efficiencies were not only highly reproducible but also showing a general increasing trend at the higher glucose concentration (see graph 1204). Although TD_MLE produced similar output as flimGANE at 2 mM condition, as TD_LSE, TD_MLE, and DFD_LSE did not provide an accurate lifetime estimate under photon-starved conditions (50-100 photons per pixel), the sensor response deviated from the correct trend at high glucose concentration (5, 10 and 15 mM glucose concentrations). It was thus demonstrated that the flimGANE method not only produces a correct sensor response curve, but also provides results 2800-fold faster than the TD_MLE method to reconstruct FLIM image analysis. While the intensity-based method, E=1−(FDA/FD), was used to estimate E, the resulting response curve clearly deviated from the reasonable trend, possibly due to artifacts such as photobleaching.

### Quantifying Metabolic States in Live HeLa Cells

Autofluorescence of endogenous fluorophores, such as nicotinamide adenine dinucleotide (NADH), nicotinamide adenine dinucleotide phosphate (NADPH), and flavin adenine dinucleotide (FAD), are often used to characterize the metabolic states of individual cancer cells, through metrics such as optical redox ratio (ORR), optical metabolic imaging index (OMI index) and fluorescence lifetime redox ratio (FLIRR). Because the fluorescence signatures of NADH and NADPH overlap, they are often referred to as NAD(P)H in literature. NAD(P)H (electron donors) and FAD (an electron acceptor) are metabolic coenzymes in live cells, whose autofluorescence intensity ratio reflects the redox states of the cells and the shifts in the metabolic pathways. However, intensity-based metrics (e.g., ORR) often suffer from wavelength- and depth-dependent light scattering and absorption issues in characterizing the metabolic states of tumor tissues. In contrast, fluorescence lifetime-based metrics (e.g., FLIRR) bypass these issues, revealing the protein-binding activities of NAD(P)H and FAD. As ORR and fluorescence lifetimes of NAD(P)H and FAD provide complementary information, they have been combined into the OMI index that can distinguish drug-resistant cells from drug-responsive cells in tumor organoids.

Live HeLa cells were seeded onto an optical imaging 8-well Lab-Tek chambered cover glass with cell density 70-90% confluent per well and grown overnight at 37° C. in a humidified atmosphere with 5% CO2. Before taking an autofluorescence FLIM image, the medium was replaced with phenol red-free complete medium. A diode laser was used as an excitation source at 405 nm. The FLIM images were taken by the laser light focused through a 60× NA=1.2, water immersion objective. The autofluorescence of NAD(P)H/FAD and were detected by two avalanche photodiodes after passing through the bandpass filters, respectively. FLIM images (512×512 pixels) were scanned one time with dwell time 0.1 ms/pixel. Alexa 405 in water (3.6 ns) was used for calibrating FLIM system.

It was demonstrated that flimGANE provides rapid, accurate and precise autofluorescence FLIM images of live HeLa cells. DFD data at two emission channels (NAD(P)H: 425-465 nm and FAD:511-551 nm) were collected by the confocal scanning system (with 405 nm excitation) and the acquired data were analyzed by TD_LSE, TD_MLE, DFD_LSE and flimGANE to generate intensity and FLIM images (see images 1301 and 1302 in FIG. 13). Because the NAD(P)H signals came from both the mitochondrial oxidative phosphorylation and cytosolic glycolysis and the FAD signals mainly originated from the mitochondria, image segmentation was often performed to deduce the relative contributions of oxidative phosphorylation and glycolysis to the cellular redox states and help quantify the heterogeneity of cell responses. An intensity threshold was selected to isolate the mitochondrial regions from the rest of the cell area, where the nuclei were manually zeroed (see diagram 1303 in FIG. 13).

With reference to FIG. 13, a deep-learning enabled metabolism quantification from low-photon-count autofluorescence FLIM imaging with live HeLa cells is shown. Images 1301 are intensity contrast images of FAD and NAD(P)H. Images 1302 are FLIM images generated by TD_LSE, TD_MLE, DFD_LSE and flimGANE of FAD and NAD(P)H. Diagram 1303 shows the Intensity contrasts from image 1301 normalized for the segmentation of mitochondria, cytoplasm, and nuclei. Graph 1304 is a comparison of FLIRR for redox states obtained from TD_LSE, TD_MLE, DFD_LSE, and flimGANE.

Intensity contrasts of both FAD and NAD(P)H images were normalized to the scale, 0-1. The normalized value for each pixel was determined by the following equation:

$${τ}_{normalized} = \frac{{τ}_{original} - {τ}_{min}}{{τ}_{max} - {τ}_{min}} \qquad Equation 15$$

Given both normalized images, the locations of segmented mitochondria were verified where the value presenting the specific location was greater than the threshold. In this example, the threshold was set at 0.25. The locations of segmented cytoplasm were determined between 0.16 and 0.25. The locations of segmented nuclei were determined between 0.06 and 0.16.

Here FLIRR (α_{2_NAD(p)H}/α_{1_FAD}) was used as a metric to assess the metabolic response of cancer cells to an intervention. Again, the flimGANE method outperformed the TD_LSE, TD_MLE, and DFD_LSE method, generating results most similar to those found in literature, where the peak of FLIRR of cancer cells is usually located at 0.2-0.4 (see graph 1304). TD_LSE and DFD_LSE provided an incorrect representation, where the former was largely skewed by the low FLIRR values and the latter showed two unrealistic peaks. TD_MLE gave a distribution similar to that of flimGANE, but with a larger FLIRR peak value, due to the inaccurate estimate of NAD(P)H lifetime under photon-starved conditions.

Quantifying the Quality of Estimate (G-Quality Score) in flimGANE

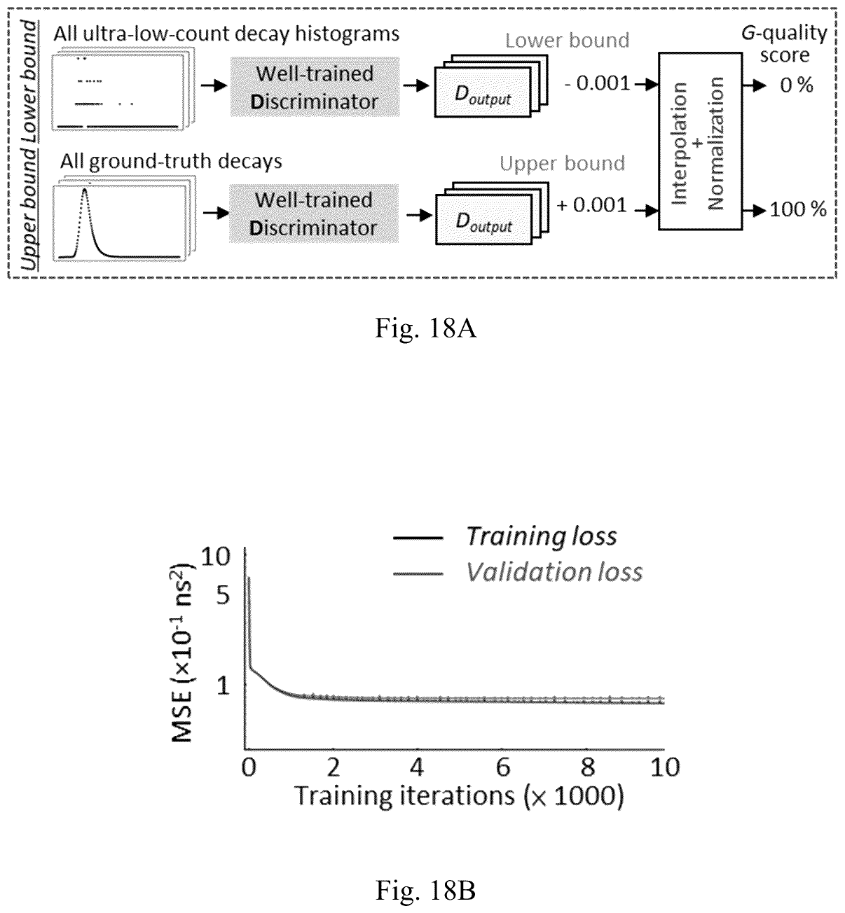

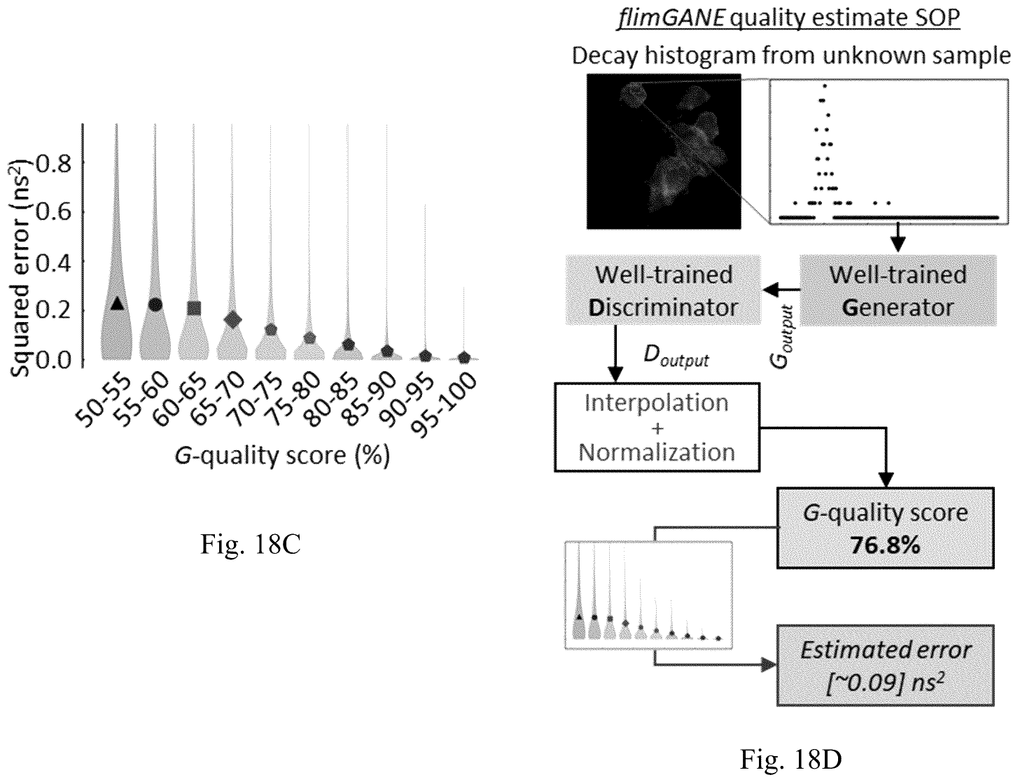

With ground-truth data available, the discriminator (D) can provide a quality estimate metric for the generator (G). Wasserstein distance was employed as the value function to train flimGANE and a 1-Lipschitz function was implemented in D to rate the quality of Gₒᵤₜₚᵤₜ. Assuming that x and \tilde{x} represent the distribution of ground-truth decays and Gₒᵤₜₚᵤₜ, D was designated to maximize the objective function in order to gauge the difference between Gₒᵤₜₚᵤₜ and the ground truth (see FIG. 18A). FIG. 18A shows that the lower and upper bounds of discriminator output were determined by the minimum of Dₒᵤₜₚᵤₜ from all the ultra-low-count decay histograms. It was then mapped to G-quality score in a range of 0 to 100% via interpolation and normalization. Because Dₒᵤₜₚᵤₜ was a relative measure and depended on the model configuration and the dataset, Dₒᵤₜₚᵤₜ was interpolated and normalized to a value between 0 and 100%, creating a quality factor termed G-quality score (see FIG. 18A). The larger the difference between Gₒᵤₜₚᵤₜ and ground truth, the lower the G-quality score. G-quality score provides a quantitative standard to evaluate flimGANE performance for samples.

The performance of flimGANE can be assessed through the training and validation losses (mean-squared error, MSE; FIG. 18B). Both training and validation losses dropped quickly and converged to a certain value (0.07 ns²) after thousands of training iterations. It was confirmed that E was not overfitted by having similar validation and training losses. With a well-trained flimGANE, a separate simulated dataset (not for network training and validation) was generated to capture the relationship between G-quality score and lifetime estimation error (see FIG. 18C). This resulted in a higher G-quality score, meaning that the better lifetime estimate had a smaller error. A demonstration of the quality estimate is shown with a live HeLa cell sample. Given an input decay histogram in the absence of ground-truth lifetime, a G-quality score of 76.8% can be obtained via the flimGANE quality estimate standard of procedure (SOP) (see FIG. 18D). As shown in FIG. 18C, an estimated error of 0.09 ns² was obtained for the current lifetime estimate.

### Discussion

As shown in Table 2 above, five training datasets were employed to train the generative adversarial network (GAN) separately that eventually led to the results discussed herein. The primary reason for retraining the model is due to the change of IRF. Whenever a different laser source is chosen for excitation, the filters are replaced, or the optics system is realigned, the IRF can also change and the network should be retrained. The second reason for retraining is the change of the lifetime range of interest. With a new IRF, it takes more than 500 hours to train the network with a lifetime range of 0.1-10 ns (τ₁ and τ₂) and a pre-exponential factor range of 0-1 (for α₁). However, if the lifetime of interest is known to be within a certain range (e.g., 1.9 and 3.5 ns as two lifetime components for different barcode beads and 0.5-5 ns for live HeLa cell), a smaller training dataset can be used to speed up the training process. While flimGANE provides rapid, accurate and fit-free FLIM analysis, its cost lies in the network training. In other words, flimGANE is particularly valuable for FLIM applications where retraining is not frequently required. Examples include samples having similar fluorophore compositions (i.e., autofluorescence from metabolites in patient-derived organoids), while the IRF is stable and seldom changes. flimGANE provides both high throughput and high quality in FLIM analysis that cannot be simultaneously achieved by the TD_LSE, TD_MLE or DFD_LSE methods.

While training datasets with a smaller lifetime range shortens the training time and using finer increments gives more precise lifetime estimates, they introduce biases at the boundaries. When a dataset with a lifetime range of 0.5-5 ns is used to train the network for Convallaria image analysis, the resulting lifetimes also fall within the same range. Any pixels with lifetimes longer than 5 ns are likely to be estimated by flimGANE as 5 ns, creating a bias at the upper bound. While these boundary biases are often not a problem for structure visualization (see e.g. FIG. 11A and FIG. 11B), they should be carefully examined in FRET and metabolic state characterization (see e.g. FIG. 12A and FIG. 13).

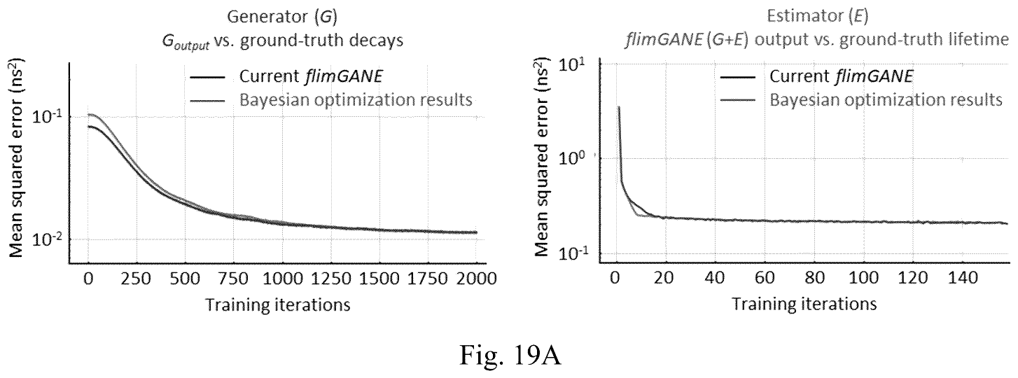

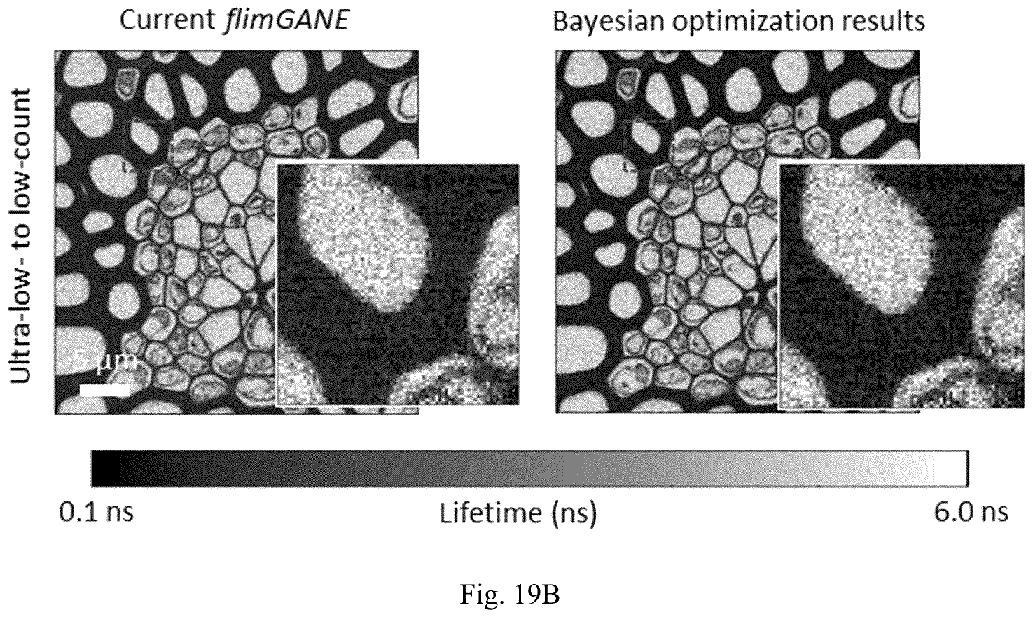

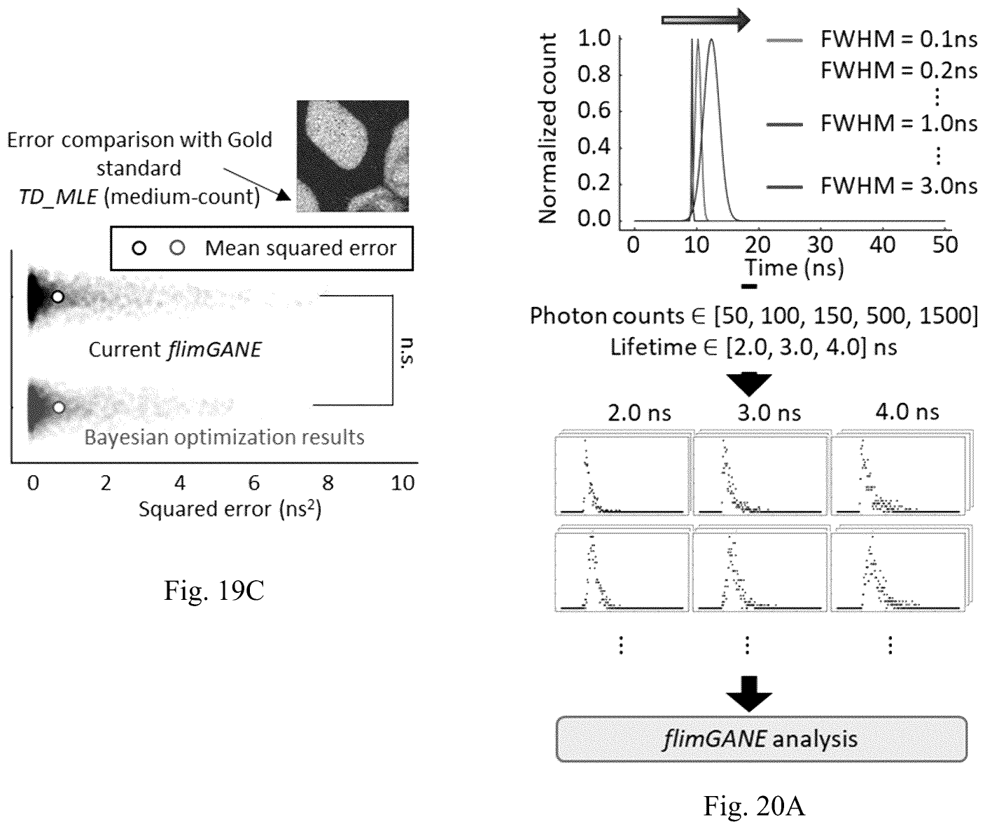

For the deep learning algorithm, it is important to optimize the hyperparameters (e.g., layer numbers, learning rates, etc). FIG. 19A, FIG. 19B, and FIG. 19C show that there was no significant difference between the Bayesian optimization results and the flimGANE results. After training the generator and estimator using the hyperparameters obtained from Bayesian optimization, the training loss over iterations was similar to that of the flimGANE algorithm (˜0.01 ns², and ˜0.20 ns² for G and E, respectively, at the end of training; see FIG. 19A). FIG. 19A shows that both Bayesian optimization results and flimGANE results end.

The Convallaria FLIM images generated by Bayesian optimization and original flimGANE were almost identical (p=0.32, two-sided paired t-test; see FIG. 19B and FIG. 19C). As shown in FIG. 19C, the squared error of the flimGANE system and the gold standard reference system were nearly identical.

The disclosed deep learning-based approach allows for the generation of high-count decay curves (high QI) directly from low-count decay curves (low QI), allowing the network to focus on the task of lifetime estimation of a previously unseen input decay curve. Accurate lifetime estimation is then achieved based on the reconstructed high QI fluorescence decay curve. In the disclosed examples the performance of presented methods was first evaluated with in-silico data, showing that flimGANE can still generate accurate lifetime estimate with photon counts as low as 50. A multiplexing concept was demonstrated by manipulating the fluorescence decay lifetimes to create temporal coding dimensions in a 10 ns range.

Once the neural network is trained, in some embodiments it can remain fixed to rapidly generate batches of FLIM images at a rate of, for example, 0.32 ms per pixel (258 times faster than the typical 82.40 ms of analysis time per pixel) for an image size of 512×512 pixels without using a graphics processing unit (GPU). In other embodiments, it may be kept trainable to further optimize the deep network through fine-tuning. The inference of the network is non-iterative and does not require a parameter search to perfect its performance. Such an analysis procedure offers the benefits of rapidly imaging the fields of view, creating high-accuracy FLIM images with fewer photons and lower light doses, which enables new opportunities for imaging objects with reduced photo-bleaching and photo-toxicity.

In addition, an essential step of the presented GAN-based framework is the accurate alignment between the instrument response function and the recorded fluorescence decay curves, and the registration with corresponding IRF. The disclosed framework provided generalized capability of hardware implementation. This multi-stage registration process (see FIG. 2C) allows the network to learn a pixel-to-pixel transformation and is used as a resampling algorithm on the network to quantify the lifetime values, while avoiding the decay shift of the input curves, which in turn significantly reduces potential artifacts.

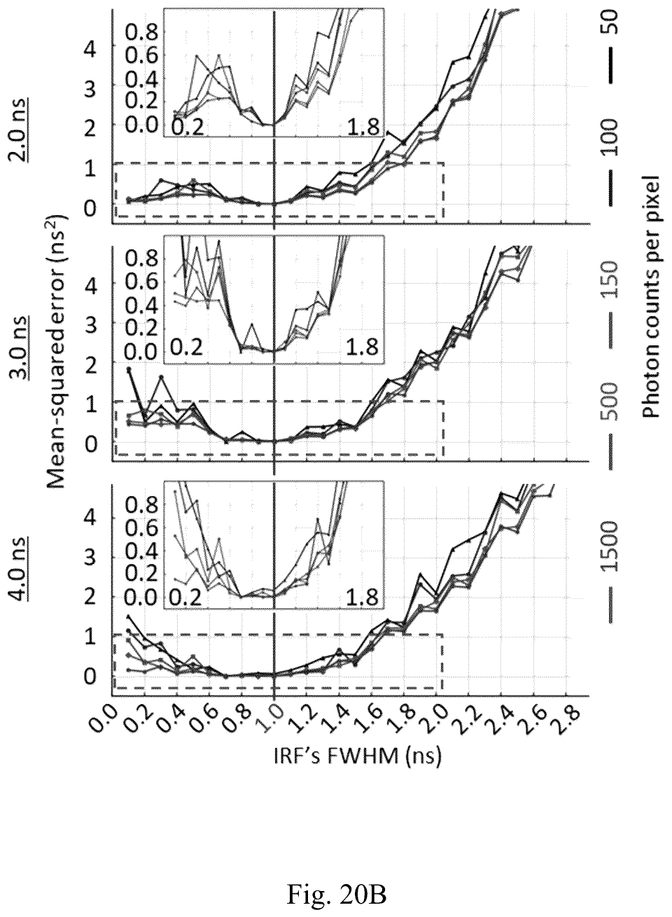

To evaluate the influence of changing IRF on flimGANE output, separate simulations were performed based on Gaussian-shaped IRFs with varying widths, ranging from 0.1 to 3.0 ns (FWHM, FIG. 20A). In standard flimGANE training, the IRF was fixed at 1.0 ns FWHM. Lifetimes ranging from 2.0-4.0 ns and five photon-count conditions (50, 100, 150, 500, 1500 photons per pixel) were used in the simulations (see FIG. 20A). Correct and stable lifetime estimates were observed when the IRF fluctuation was within ±0.2 ns. (i.e., ±20% FWHM from 1.0 ns; FIG. 20B). The mean-squared errors were less than 0.2 ns², which indicated that a well-trained flimGANE for lifetime estimation can still be used without retraining.

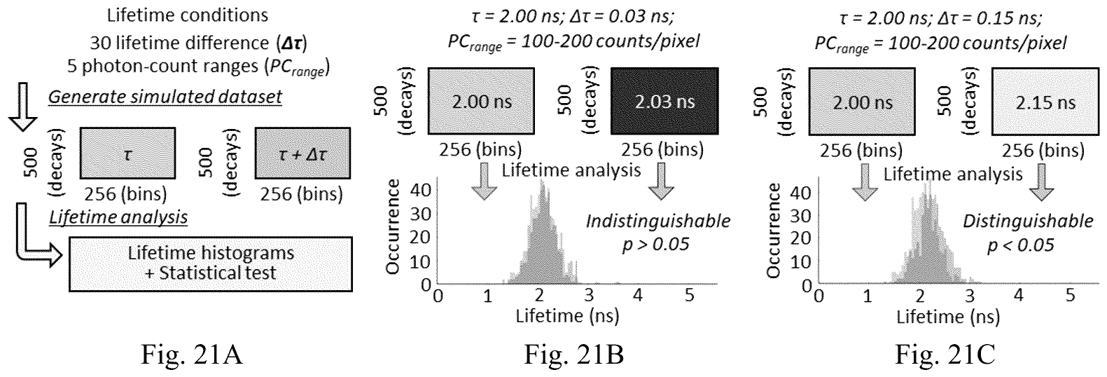

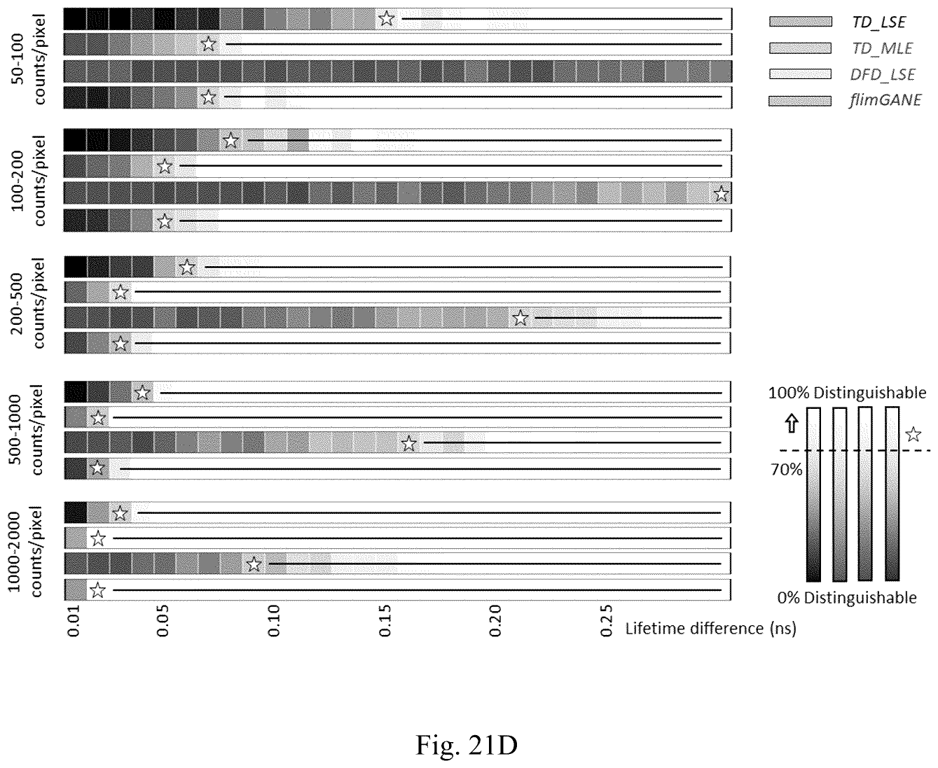

To understand how reliable flimGANE can be in differentiating subtle lifetime differences under low-photon-count conditions (100-200 photons per pixel), the “limits of lifetime differentiation” (hereafter denoted as discriminability) of the four analysis methods (TD_LSE, TD_MLE, DFD_LSE, and flimGANE) were tested using a reference lifetime of 2.00 ns and under photon-count conditions (see FIG. 21A). 500 simulated decays were generated for each τ, with Arranging from 0.01-0.30 ns τ=2.00, 2.01, . . . 2.30 ns). The mean lifetime was extracted from 500 lifetime estimates (by Gaussian fitting of the histogram) and each Δτ was tested 20 times. Using the p-value <0.05 in a two-sided KS test as a criterion, if the p-value was less than for 70% of the repeated tests, there was a significant difference between two lifetime distributions. For instance, 2.00 ns decay and 2.03 ns decays were indistinguishable as their p-value was 0.33 (p-value >0.05; see FIG. 21B), By contrast, 2.00 ns decay and 2.15 ns decay were distinguishable with a p-value of 1.95×10⁻¹⁶ (p-value <0.05; see FIG. 21C). In all 5 photon-count conditions, flimGANE and TD_MLE had the same discriminability (FIG. 21D). As expected, higher photon counts per pixel improved the discriminability.

The key feature of flimGANE is the conversion of a low-count decay histogram into a high-count decay histogram through generative models. Wasserstein loss was employed to avoid vanishing gradients and mode collapse. While flimGANE may generate inaccurate conversions when the quality of the input decay histogram is extremely low (e.g. fluorescence decay histogram with less than 50 photons), a WGAN-based generative model holds great potential to being improved, including for example the use of a gradient penalty (WGAN-GP), the sequence generation framework, and the context-aware learning. In some embodiments, transfer learning from a previously trained network for another type of sample is used to speed up the convergence of the learning process. However, this is neither a replacement nor a required step for the entire training process. After a sufficiently large number of training iterations for the generator (in some embodiments >2,000), the optimal network is identified when the validation loss no longer decreases.

The disclosed work represents an important step forward for the fields of fluorescence lifetime imaging microscopy, and should help generate low-photon-count-based FLIM images accurately, potentially enabling a new application as the foundation for future libraries of nano-/microprobes carrying more than 3,000 codes (solely via the combination of intensity and lifetime) and biological observations beyond what can be achieved in well-resource system settings. Temporal resolution was improved as data acquisition time was reduced without losing any useful information, a significant advantage for monitoring microenvironments in living cells and understanding the underlying mechanisms of molecular interactions.

In summary, FLIM is a unique tool used to quantify molecular compositions and study the molecular states in complex cellular environments as the lifetime readings are not biased by the fluorophore concentration or the excitation power. However, the current methods to generate FLIM images are either computationally intensive or unreliable when the number of photons acquired at each pixel is low. The flimGANE (fluorescence lifetime imaging based on Generative Adversarial Network Estimation) method disclosed herein provides rapid and accurate analysis of one- or two-component fluorescence decays with a low-photon budget. Without running any costly iterative computations to fit the decay histograms, flimGANE directly estimated the fluorescence lifetime and molecular fraction of each fluorescent component using an adversarial network, generating a 512×512 FLIM image 258 times faster than the time-domain least-squares estimation (TD_LSE) method and 2,800 times faster than the time-domain maximum likelihood estimation (TD_MLE) method. Although the digital frequency-domain least-squares estimation (DFD_LSE) method had a relatively higher speed in lifetime analysis, flimGANE was still 12 times faster than DFD_LSE. In addition, flimGANE provided more accurate lifetime estimates at photon-starved conditions (˜50 photons per pixel), leading to a 2.1-fold increase in the FLIM image quality measured by PSNR. As the disclosed method is the only method that provides both efficiency and accuracy in generating FLIM images and works particularly well for analyzing low-photon-count decays, the disclosed method is a suitable replacement for conventional lifetime analysis methods in applications where the speed and the reliability of FLIM images are critical, such as identification of a tumor-free surgical margin during tumor surgery.

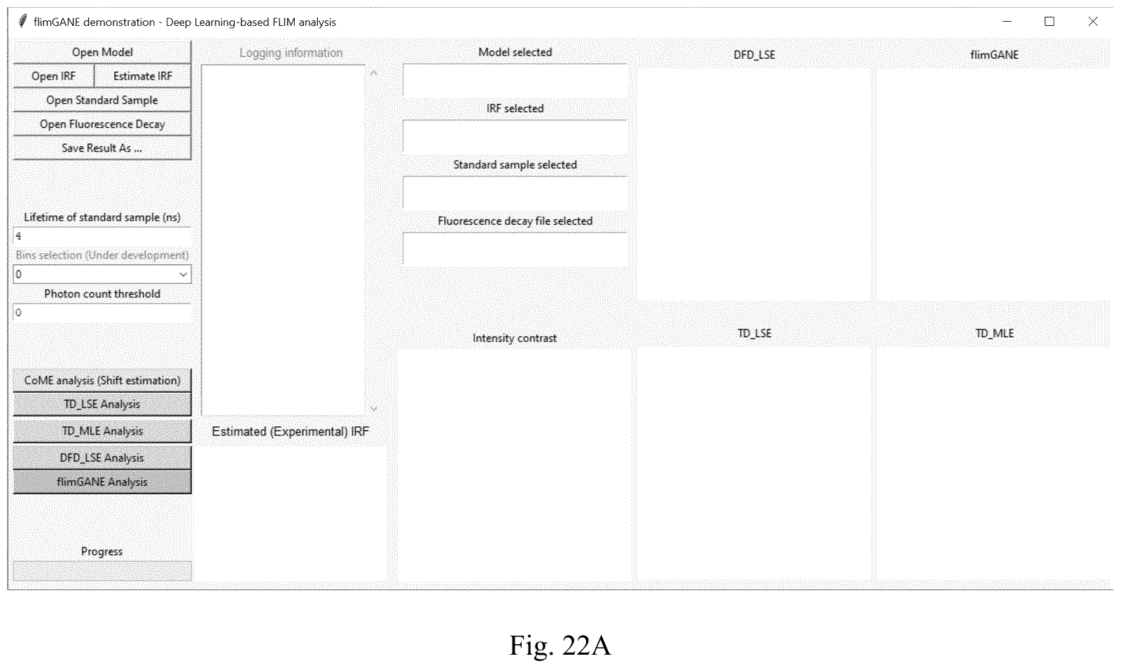

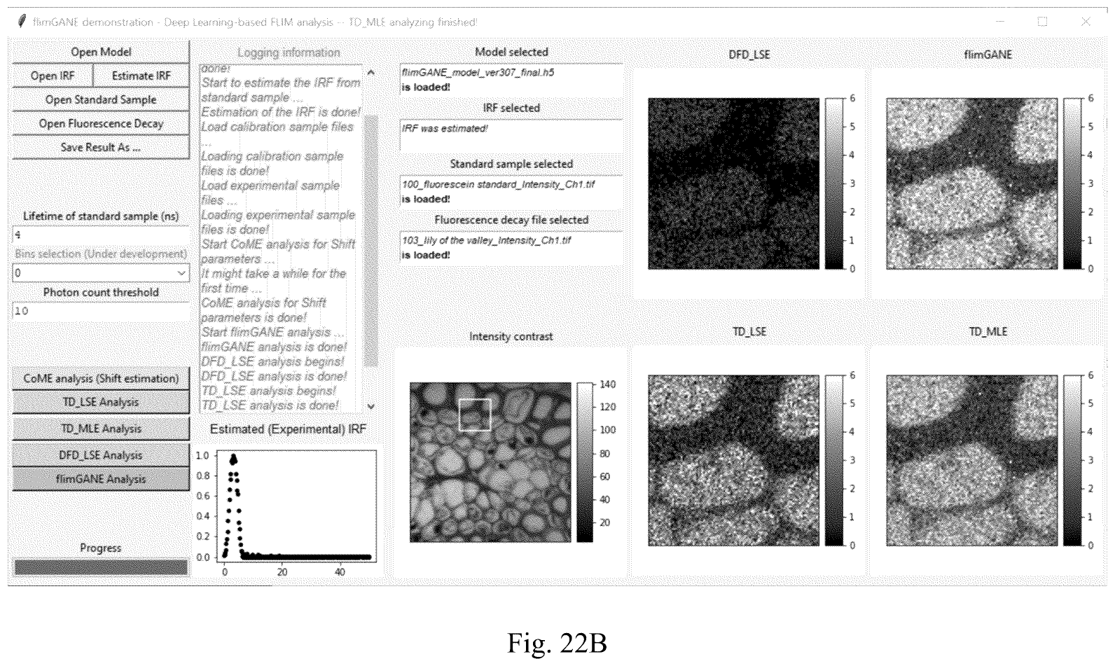

A stand-alone GUI for flimGANE software is shown in FIG. 22A and FIG. 22B. In one embodiment, a GUI of the disclosure includes FLIM image generation using flimGANE. In another embodiment, a GUI of the disclosure includes the additional function of CoME analysis to correct the shift value of fluorescence decays. In one embodiment, a GUI includes the functions of implementing DFD_LSE, TD_LSE, and TD_MLE, IRF deconvolution/estimation, a log box showing the current status of the analysis pipeline, and/or a progress bar indicating the percentage of FLIM image pixels generated, to inform the user of processing duration.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCES

The following publications are incorporated herein by reference in their entireties:
Berezin, M. Y. & Achilefu, S. Fluorescence lifetime measurements and biological imaging. Chemical reviews 110, 2641-2684 (2010).
Suhling, K. et al. Fluorescence lifetime imaging (FLIM): basic concepts and some recent developments. Medical Photonics 27, 3-40 (2015).
Datta, R., Heaster, T. M., Sharick, J. T., Gillette, A. A. & Skala, M. C. Fluorescence lifetime imaging microscopy: fundamentals and advances in instrumentation, analysis, and applications. Journal of Biomedical Optics 25, 071203 (2020).
Ogikubo, S. et al. Intracellular pH sensing using autofluorescence lifetime microscopy. The Journal of Physical Chemistry B 115, 10385-10390 (2011).
Kuimova, M. K., Yahioglu, G., Levitt, J. A. & Suhling, K. Molecular rotor measures viscosity of live cells via fluorescence lifetime imaging. Journal of the American Chemical Society 130, 6672-6673 (2008).
Okabe, K. et al. Intracellular temperature mapping with a fluorescent polymeric thermometer and fluorescence lifetime imaging microscopy. Nature communications 3, 1-9 (2012).
Gerritsen, H. C., Sanders, R., Draaijer, A., Ince, C. & Levine, Y. Fluorescence lifetime imaging of oxygen in living cells. Journal of Fluorescence 7, 11-15 (1997).
Skala, M. C. et al. In vivo multiphoton microscopy of NADH and FAD redox states, fluorescence lifetimes, and cellular morphology in precancerous epithelia. P Natl Acad Sci USA 104, 19494-19499 (2007).
Unger, J. et al. Method for accurate registration of tissue autofluorescence imaging data with corresponding histology: a means for enhanced tumor margin assessment. J Biomed Opt 23, 015001 (2018).
Marx, V. Probes: FRET sensor design and optimization. Nature Methods 14, 949-953 (2017).
Grant, D. M. et al. Multiplexed FRET to image multiple signaling events in live cells. Biophys J 95, L69-L71 (2008).
Lakowicz, J. R. & Szmacinski, H. Fluorescence lifetime-based sensing of pH, Ca2+, K+ and glucose. Sensors and Actuators B: Chemical 11, 133-143 (1993).
Sun, Y., Day, R. N. & Periasamy, A. Investigating protein-protein interactions in living cells using fluorescence lifetime imaging microscopy. Nature protocols 6, 1324 (2011).
Bastiaens, P. I. & Squire, A. Fluorescence lifetime imaging microscopy: spatial resolution of biochemical processes in the cell. Trends in cell biology 9, 48-52 (1999).
Wallrabe, H. & Periasamy, A. Imaging protein molecules using FRET and FLIM microscopy. Current Opinion in Biotechnology 16, 19-27 (2005).
Schrimpf, W. et al. Chemical diversity in a metal-organic framework revealed by fluorescence lifetime imaging. Nature Communications 9, 1-10 (2018).
Straume, M., Frasier-Cadoret, S. G. & Johnson, M. L. Least-squares analysis of fluorescence data. in Topics in Fluorescence Spectroscopy 177-240 (Springer, 2002).
Pelet, S., Previte, M., Laiho, L. & So, P. A fast global fitting algorithm for fluorescence lifetime imaging microscopy based on image segmentation. Biophysical Journal 87, 2807-2817 (2004).
Rowley, M. I., Barber, P. R., Coolen, A. C. & Vojnovic, B. Bayesian analysis of fluorescence lifetime imaging data. in Proceedings of SPIE Conference on Multiphoton Microscopy in the Biomedical Sciences XXI, Vol. 7903 790325 (2011).
Redford, G. I. & Clegg, R. M. Polar plot representation for frequency-domain analysis of fluorescence lifetimes. Journal of Fluorescence 15, 805 (2005).
Digman, M. A., Caiolfa, V. R., Zamai, M. & Gratton, E. The phasor approach to fluorescence lifetime imaging analysis. Biophysical Journal 94, L14-L16 (2008).
Lee, K. B. et al. Application of the stretched exponential function to fluorescence lifetime imaging. Biophysical Journal 81, 1265-1274 (2001).
Jo, J. A., Fang, Q., Papaioannou, T. & Marcu, L. Fast model-free deconvolution of fluorescence decay for analysis of biological systems. Journal of Biomedical Optics 9, 743-753 (2004).
Goodfellow, I. et al. in Advances in neural information processing systems 2672-2680 (2014).
Rivenson, Y. et al. Virtual histological staining of unlabelled tissue-autofluorescence images via deep learning. Nature biomedical engineering 3, 466 (2019).
Schawinski, K., Zhang, C., Zhang, H., Fowler, L. & Santhanam, G. K. Generative adversarial networks recover features in astrophysical images of galaxies beyond the deconvolution limit. Monthly Notices of the Royal Astronomical Society: Letters 467, L110-L114 (2017).
Wang, H. et al. Deep learning enables cross-modality super-resolution in fluorescence microscopy. Nat. Methods 16, 103-110 (2019).
Guimaraes, G. L., Sanchez-Lengeling, B., Outeiral, C., Farias, P. L. C. & Aspuru-Guzik, A. Objective-reinforced generative adversarial networks (organ) for sequence generation models. arXiv preprint arXiv:1705.10843 (2017).
Ledig, C. et al. in Proceedings of the IEEE conference on computer vision and pattern recognition 4681-4690 (2017).
Arjovsky, M., Chintala, S. & Bottou, L. Wasserstein gan. arXiv preprint arXiv:1701.07875 (2017).
Ware, W. R., Doemeny, L. J. & Nemzek, T. L. Deconvolution of fluorescence and phosphorescence decay curves. Least-squares method. The Journal of Physical Chemistry 77, 2038-2048 (1973).
Gratton, E., Breusegem, S., Sutin, J. D., Ruan, Q. & Barry, N. P. Fluorescence lifetime imaging for the two-photon microscope: time-domain and frequency-domain methods. J Biomed Opt 8, 381-391 (2003).
Becker, W. The bh TCSPC Handbook. Available on www.becker-hickl.com. Please contact bh for printed copies (2019).
Chen, Y.-I. et al. Measuring DNA hybridization kinetics in live cells using a time-resolved 3D single-molecule tracking method. Journal of the American Chemical Society 141, 15747-15750 (2019).
Liu, C. et al. 3D single-molecule tracking enables direct hybridization kinetics measurement in solution. Nanoscale 9, 5664-5670 (2017).
Turton, D. A., Reid, G. D. & Beddard, G. S. Accurate analysis of fluorescence decays from single molecules in photon counting experiments. Anal Chem 75, 4182-4187 (2003).
Laurence, T. A. & Chromy, B. A. Efficient maximum likelihood estimator fitting of histograms. Nat Methods 7, 338-339 (2010).
Colyer, R. A., Lee, C. & Gratton, E. A novel fluorescence lifetime imaging system that optimizes photon efficiency. Microsc Res Techniq 71, 201-213 (2008).
Yang, H. et al. Protein conformational dynamics probed by single-molecule electron transfer. Science 302, 262-266 (2003).
Elson, D. et al. Real-time time-domain fluorescence lifetime imaging including single-shot acquisition with a segmented optical image intensifier. New J Phys 6, 180 (2004).
Buller, G. & Collins, R. Single-photon generation and detection. Measurement Science and Technology 21, 012002 (2009).
Silva, S. F., Domingues, J. P. & Morgado, A. M. Accurate Rapid Lifetime Determination on Time-Gated FLIM Microscopy with Optical Sectioning. Journal of healthcare engineering 2018 (2018).
Ma, G., Mincu, N., Lesage, F., Gallant, P. & McIntosh, L. in Imaging, Manipulation, and Analysis of Biomolecules and Cells: Fundamentals and Applications III, Vol. 5699 263-273 (International Society for Optics and Photonics, 2005).
Lakowicz, J. R. Fluorescence spectroscopic investigations of the dynamic properties of proteins, membranes and nucleic acids. Journal of Biochemical and Biophysical Methods 2, 91-119 (1980).
Wang, Z., Bovik, A. C., Sheikh, H. R. & Simoncelli, E. P. Image quality assessment: from error visibility to structural similarity. IEEE transactions on image processing 13, 600-612 (2004).
Sheikh, H. R. & Bovik, A. C. A visual information fidelity approach to video quality assessment. in International Workshop on Video Processing and Quality Metrics for Consumer Electronics, Vol. 7 2 (2005).
Veetil, J. V., Jin, S. & Ye, K. (SAGE Publications, 2012).
Takanaga, H., Chaudhuri, B. & Frommer, W. B. GLUT1 and GLUT9 as major contributors to glucose influx in HepG2 cells identified by a high sensitivity intramolecular FRET glucose sensor. Biochimica et Biophysica Acta (BBA)-Biomembranes 1778, 1091-1099 (2008).
Chance, B., Schoener, B., Oshino, R., Itshak, F. & Nakase, Y. Oxidation-reduction ratio studies of mitochondria in freeze-trapped samples—NADH and Flavoprotein fluorescence signals. J Biol Chem 254, 4764-4771 (1979).
Walsh, A. J. et al. Quantitative optical imaging of primary tumor organoid metabolism predicts drug response in breast cancer. Cancer Res 74, 5184-5194 (2014).
Wallrabe, H. et al. Segmented cell analyses to measure redox states of autofluorescent NAD (P) H, FAD & Trp in cancer cells by FLIM. Scientific Reports 8, 1-11 (2018).
Walsh, A. J., Castellanos, J. A., Nagathihalli, N. S., Merchant, N. B. & Skala, M. C. Optical imaging of drug-induced metabolism changes in murine and human pancreatic cancer organoids reveals heterogeneous drug response. Pancreas 45, 863 (2016).
Alam, S. R. et al. Investigation of mitochondrial metabolic response to doxorubicin in prostate cancer cells: an NADH, FAD and tryptophan FLIM assay. Scientific reports 7, 1-10 (2017).
Cao, R., Wallrabe, H., Siller, K., Rehman Alam, S. & Periasamy, A. Singlecell redox states analyzed by fluorescence lifetime metrics and tryptophan FRET interaction with NAD (P) H. Cytometry Part A 95, 110-121 (2019).
Penjweini, R. et al. Single cell-based fluorescence lifetime imaging of intracellular oxygenation and metabolism. Redox Biology, 101549 (2020).
Wu, G., Nowotny, T., Zhang, Y., Yu, H.-Q. & Li, D. D.-U. Artificial neural network approaches for fluorescence lifetime imaging techniques. Optics Letters 41, 2561-2564 (2016).
Smith, J. T. et al. Fast fit-free analysis of fluorescence lifetime imaging via deep learning. Proceedings of the National Academy of Sciences (2019).
He, K., Zhang, X., Ren, S. & Sun, J. Deep residual learning for image recognition. In Proceedings of the IEEE Conference on Computer Vision and Pattern Recognition 770-778 (2016).
Gulrajani, I., Ahmed, F., Arjovsky, M., Dumoulin, V. & Courville, A. C. in Advances in neural information processing systems 5767-5777 (2017).
Yu, L., Zhang, W., Wang, J. & Yu, Y. in Thirty-first AAAI conference on artificial intelligence (2017).
Perdikis, S., Leeb, R., Chavarriaga, R. & Millan, J. d. R. Context-aware Learning for Generative Models. IEEE Transactions on Neural Networks and Learning Systems (2020).
Pan, S. J. & Yang, Q. A survey on transfer learning. IEEE Transactions on Knowledge and Data Engineering 22, 1345-1359 (2009).
Castello, M. et al. A robust and versatile platform for image scanning microscopy enabling super-resolution FLIM. Nature Methods 16, 175-178 (2019).
Niehorster, T. et al. Multi-target spectrally resolved fluorescence lifetime imaging microscopy. Nature Methods 13, 257-262 (2016).
Alfonso Garcia, A. et al. Realtime augmented reality for delineation of surgical margins during neurosurgery using autofluorescence lifetime contrast. Journal of Biophotonics 13, e201900108 (2020).
Dysli, C. et al. Fluorescence lifetime imaging ophthalmoscopy. Progress in Retinal and Eye Research 60, 120-143 (2017).

We claim:

1. A fluorescence lifetime imaging microscopy system, comprising:
a microscope, comprising an excitation source configured to direct an excitation energy to an imaging target, and a detector configured to measure emissions of energy from the imaging target; and
a non-transitory computer-readable medium with instructions stored thereon, which when executed by a processor perform steps comprising:
collecting a quantity of measured emissions of energy from the imaging target as measured data;
providing a trained neural network configured to calculate fluorescent decay parameters from the quantity of measured emissions of energy;
providing the measured data to the trained neural network; and
calculating at least one fluorescence lifetime parameter with the neural network from the measured data;
wherein the measured data comprises an input fluorescence decay histogram having a photon count of no more than 200; and
wherein the neural network was trained by a generative adversarial network.

2. The system of claim 1, the steps further comprising providing an instrument response function curve to the trained neural network.

3. The system of claim 1, wherein the measured data comprises a fluorescence decay histogram having a photon count of no more than 100.

4. The system of claim 1, the steps further comprising:
generating a synthetic fluorescence decay histogram having a photon count higher than the input fluorescence decay histogram; and
calculating the at least one fluorescence lifetime parameter from the synthetic fluorescence decay histogram.

5. The system of claim 1, the steps further comprising:
calculating a center of mass of an instrument response function curve;
calculating a center of mass of the input fluorescence decay histogram; and
time-shifting the input fluorescence decay histogram based on a difference between the center of mass of the instrument response function curve and the center of mass of the input fluorescence decay histogram.

6. The system of claim 1, wherein the excitation source comprises at least one laser.

7. The system of claim 6, wherein the at least one laser comprises a plurality of lasers configured to deliver sub-nanosecond pulses.

8. The system of claim 1, wherein the detector comprises a scanning mirror.

9. The system of claim 1, wherein the detector comprises at least one pinhole.

10. The system of claim 1, wherein the generative adversarial network is a Wasserstein generative adversarial network.

11. A method of training a neural network for a fluorescence lifetime imaging microscopy system, comprising:
generating a synthetic high-count fluorescence lifetime decay histogram from an instrument response function and an exponential decay curve;
generating a synthetic low-count fluorescence lifetime decay histogram from the synthetic high-count fluorescence lifetime decay histogram;
providing a generative adversarial network comprising a generator network and a discriminator network;
generating a plurality of candidate high-count fluorescence lifetime decay histograms from the synthetic low-count fluorescence lifetime decay histogram with the generator network;
training the discriminator network with the synthetic high-count fluorescence lifetime decay histograms and the candidate high-count fluorescence lifetime decay histograms; and
training the generator network with the results of the discriminator network training;
wherein the synthetic low-count fluorescence lifetime decay histogram has a photon count of no more than 200.

12. The method of claim 11, wherein the synthetic high-count fluorescence lifetime decay histogram are generated by a Monte Carlo simulation.

13. The method of claim 11, wherein the synthetic low-count fluorescence decay histogram is generated by a Monte Carlo simulation.

14. The method of claim 13, further comprising:
providing an instrument response function curve;
convolving the instrument response function curve with a two-component exponential decay equation to provide a continuous fluorescence exponential decay curve; and
performing the Monte Carlo simulation with the continuous fluorescence decay curve to generate the synthetic low-count decay histogram.

15. The method of claim 14, further comprising normalizing the continuous fluorescence exponential decay curve.

16. The method of claim 11, wherein the synthetic low-count fluorescence decay histogram is generated by a Poisson process.

17. The method of claim 11, further comprising:
providing a plurality of high-count fluorescence lifetime decay histograms with known lifetime parameters; and
training an estimator network with the plurality of high-count fluorescence lifetime decay histograms and the known lifetime parameters to calculate estimated lifetime parameters.

18. The method of claim 11, further comprising:
selecting a subset of the candidate high-count fluorescence decay histograms;
selecting a subset of the synthetic high-count decay histograms; and
training the discriminator network with the subset of candidate high-count fluorescence decay histograms and the subset of synthetic high-count decay histograms, to discriminate between a true high-count decay histogram and a synthetic high-count decay histogram.

19. The method of claim 11, further comprising:
training a denoising neural network with a plurality of noisy fluorescence decay histograms and a plurality of generated, low-noise fluorescence decay histograms, the trained denoising neural network configured as a pre-processing step for the generative adversarial network.

20. A method of acquiring an image from a fluorescence lifetime imaging microscopy system, comprising:
providing a microscope comprising an excitation source and a detector;
directing an excitation energy to an imaging target;
collecting a quantity of measured emissions of energy from the imaging target with the detector as measured data;
providing a trained neural network configured to calculate fluorescent decay parameters from the quantity of measured emissions of energy;
providing the measured data to the trained neural network;
calculating at least one fluorescence lifetime parameter with the neural network from the measured data; and
repeating the collecting and calculating steps to generate an at least two-dimensional fluorescence lifetime image of the imaging target;
wherein the measured data comprises an input fluorescence decay histogram having a photon count of no more than 200; and
wherein the neural network was trained by a generative adversarial network.

21. The method of claim 20, wherein the neural network comprises a generator network configured to generate a synthetic fluorescence decay histogram from the input fluorescence decay histogram, the synthetic fluorescence decay histogram having a higher photon count than the input fluorescence decay histogram.

22. The method of claim 21, wherein the neural network further comprises an estimator network configured to estimate the values of at least one fluorescence lifetime parameter from the synthetic fluorescence decay histogram.

23. The method of claim 20, further comprising providing the trained neural network with an instrument response function.

24. The method of claim 20, further comprising:
performing an unsupervised cluster analysis;
grouping a set of pixels with similar patterns; and
summing the set of pixels in order to increase the signal-to-noise ratio of the input fluorescence decay histogram.

25. The method of claim 20, wherein the at least two-dimensional fluorescence lifetime image of the imaging target is generated at least 20× faster than with a conventional analysis method.
